(19) United States
(12) Patent Application Publication
(10) Pub. No.: US 2026/0111918 A1
(43) Pub. Date: Apr. 23, 2026

(54) SYSTEMS AND METHODS FOR ANALYSIS AND DESIGN SOFTWARE TO ENABLE A SUSTAINABLE CIRCULAR ECONOMY OF MULTILAYER BARRIER FILMS

(71) Applicants: Farshid Nazemi, Tempe, AZ (US); Bhavik Bakshi, Scottsdale, AZ (US)

(72) Inventors: Farshid Nazemi, Tempe, AZ (US); Bhavik Bakshi, Scottsdale, AZ (US)

(73) Assignee: Arizona Board of Regents on Behalf of Arizona State University, Tempe, AZ (US)

(21) Appl. No.: 19/366,313

(22) Filed: Oct. 22, 2025

Related U.S. Application Data
(60) Provisional application No. 63/710,422, filed on Oct. 22, 2024.

(51) Int. Cl. G06Q 30/0201

(52) U.S. Cl. CPC G06Q 30/0201

(57) ABSTRACT

A software tool for analysis of the economic and global warming impact of multilayer barrier films enables the design of a sustainable circular economy for the multilayer barrier films is disclosed herein. The tool can provide circular economy analysis for a plurality of different plastic types and various potential end of life scenarios.

### CROSS REFERENCE TO RELATED APPLICATIONS

This is a non-provisional application that claims benefit to U.S. Provisional Application No. 63/710,422 filed on Oct. 22, 2024, which is herein incorporated by reference in its entirety.

### GOVERNMENT SUPPORT

This invention was made with government support under DE-EE0007897 awarded by the Department of Energy. The government has certain rights in the invention.

### FIELD

The present disclosure generally relates to sustainability and circularity analysis and optimization for barrier films and multilayer plastic films.

### BACKGROUND

Plastic films have a variety of applications and are widely used in industry. Monolayer plastic films are composed of one type of polymer (Polyethylene (PE), Polypropylene (PP), etc.) and are widely used for film-based packaging. On the other hand, multilayer plastic films are made of multiple types of resins in a co-extrusion process and are an excellent choice when very specific film properties are needed. One of the most widely used multilayer plastic films are high barrier/carrier release films that are used in the manufacturing of sheet molding compounds (SMC). SMC are thermoset fiber reinforced plastics widely used to make automobile and bath and showering products. The multilayer film acts as a substrate that carries the paste containing the base components of SMC during the production process. Moreover, the multilayer film acts as a barrier that prevents the migration of volatile compounds like styrene. This is a crucial step in the SMC manufacturing process because styrene migration will result in an increase in viscosity and premature crosslinking which will cause problems in the subsequent molding process. The film is removed from the SMC prior to the molding process and is discarded to landfill. Among many possible solutions for providing the barrier property, Polyamides (PA) or nylons, are preferred due to its market availability and properties. However, a monolayer nylon film will adhere to the styrene monomer, which makes it difficult to remove prior to the molding process. Instead, while nylon is used as the core layer of the film, polyethylene (PE) is used as the top and bottom layers because of its nonadherence properties. Finally, an adhesive agent is used to hold the nylon and polyethylene layers together, making it a five-layer PE/adhesive/nylon/adhesive/PE film.

While such plastics offer convenience and cost-efficiency in modern life due to their versatility and production scale, their widespread use has led to significant environmental challenges in global supply chains. Plastic waste accumulation in landfills and oceans harms biodiversity, while the reliance on fossil resources depletes finite reserves. Additionally, the production and transportation of plastics contribute to climate change. The current global SMC market is worth USD 2 billion, representing 6 million lb/yr of SMC barrier/carrier film waste in the US, which creates a great potential for waste recovery. However, as mentioned above the barrier/carrier film waste is currently discarded to landfill due to the lack of recycling and recovering strategies at their end of life. Reducing this waste can decrease significant environmental impacts related to large scale disposal of plastic films and consumption of primary (virgin) feedstock resources.

Unlike monolayer plastic films, multilayer films are not easy to recycle because of the presence of multiple layers of films that are chemically and thermodynamically incompatible and thus cannot be recycled using conventional plastic recycling technologies. However, in recent years, open-loop and closed-loop recycling of multilayer films have been made possible using unique techniques at laboratory, pilot, and commercial scales.

Mechanical recycling of multilayer films is being studied extensively. There are three main advanced methods to mechanically recycle multilayer plastic films. The first one includes regranulation (grinding and pelletizing) of films using a compatibilizer to make the polymer blends less immiscible and therefore more mechanically stable. Compatibilization results in one polymer stream that can be used to make other products through injection molding or blown film processes that can result in production of new monolayer and multilayer films. Nevertheless, compatibilization does not enable closed-loop recycling due to the heterogeneity needed for multilayer plastic films with unique properties and applications. The second method is delamination of individual polymer components through defunctionalizing the adhesive between each layer using a solvent. In this method, the crosslinked adhesive is specially targeted and dissolved in a solvent. Individual polymer layers can therefore be separated from each other in the absence of chemical bonding between individual polymer layers and be repalletized and substituted the virgin feedstock to reproduce the multilayer film. In the third method, a series of solvent washes is used to selectively dissolve and precipitate individual polymer layers at each stage. This method is called solvent-targeted recovery and precipitation (STRAP), and it hasn't been commercialized yet. The precipitated polymers can substitute the virgin resins used in the multilayer production process.

Among the three mechanical recycling techniques, delamination and STRAP are also considered as layer separation techniques that can be used in combination with chemical recycling processes to recycle chemicals and fuels. The individual polymers can be depolymerized to produce base monomers and/or feedstocks. Without layer separation, depolymerization is not possible due to the complex heterogenous structure of the multilayer films. Finally, among other chemical recycling methods, pyrolysis is getting a great deal of attention as a viable option to chemically recycle mixed monolayer and multilayer films without layer separation to produce fuel and carbon-rich solid products. However, yield, energy consumption and process emissions are highly dependent on the composition of the mixed plastic stream or multilayer plastic film.

Employing the abovementioned recycling techniques as recovery strategies for SMC barrier/carrier films requires addressing particular characteristics of the SMC barrier/carrier film due to its unique composition and the presence of contaminations on the film. According to Berry Global, one of the leading companies in producing SMC barrier/carrier films in the US, SMC barrier/carrier film is composed of 57 wt. % LLDPE, 26 wt. % nylon 6, and 17 wt. % polyethylene grafted maleic anhydride. In addition, SMC barrier/carrier film contains some contaminations on the surface, which are mainly styrene monomers. Although a few studies investigated some of the abovementioned mechanical treatment methods for nylon-PE films used in packaging industry, to our knowledge, there is no study on mechanical and chemical recycling of SMC barrier/carrier film with this specific composition. Moreover, the effect of styrene monomer contamination on the treatment techniques and mechanical properties of the recycled streams must be studied carefully.

Soares et al provided a review of mechanical, chemical, and thermal treatment methods for recovering multilayer plastic films at their EOL. Grutzner et al studied the mechanical recyclability of PA-PE films in a pelletization process. The studies concluded that PA-PE films are recyclable if the right amount of compatibilizer is used and process parameters are optimized. Delamination through selective dissolution of adhesive is also a viable technique in the case that polyurethane adhesives are used. The removal of adhesive leads to the separation of polymer layers and subsequently their recovery. STRAP techniques are also used to selectively dissolve each polymer layer in a specific solvent and recover the polymer through precipitation. From an energy recovery point of view, Bassey et al provided a review of thermal treatment and energy recovery options for multilayer waste plastics in Africa, and concluded that incineration, thermal pyrolysis and gasification are viable techniques for energy recovery from multilayer plastic waste. While the main focus of the literature is on overcoming the technical obstacles of multilayer film recovery through applying new and complex recovery technologies, a few studies have also focused on the environmental and circularity aspects of the recovery strategies for recycling multilayer plastic films. Costamagna et al evaluated the life cycle emissions of STRAP process as the EOL option for recycling PE-PA multilayer films used for packaging, and compared the results with other end of life options, i.e., incineration and incineration with energy recovery. The study concluded that the STRAP process outperforms incineration with and without energy recovery across all environmental indicators. Vadoudi et al performed a life cycle analysis and measured the circularity of a three-layer plastic film used in the packaging industry by considering delamination as the EOL process.

While prior studies have examined the recovery of multilayer plastic films at their end of life, there exists a gap in research concerning the experimental methodologies tailored towards the recovery of SMC film, characterized by its distinctive composition. Furthermore, current waste under study is an industrial waste with unique challenges, such as impurities originated from the SMC manufacturing process.

It is with these observations in mind, among others, that various aspects of the present disclosure were conceived and developed.

### BRIEF DESCRIPTION OF THE DRAWINGS

FIG. 1 is a flow diagram of the conventional SMC barrier/carrier film supply chain.

FIG. 2 is a graphical representation of the cradle-to-grave life cycle impact of 1 ton of SMC barrier/carrier film consumption.

FIG. 3 is a flow diagram depicting alternative end of life processes and technologies for treating SMC barrier film waste.

FIG. 4 is a graphical representation of the cost of recycled LDPE thin film from the years 2005 to 2021.

FIG. 5 is a plot depicting the comparative cradle-to-grave life cycle assessment (LCA) results for landfill and incineration scenarios.

FIG. 6 is a plot depicting the comparative LCA results for a variety of end-of-life scenarios.

FIG. 7 is a graphical representation of the Global Warming Potential (GWP) and circularity results for the boundary expansion approach for Recycle, Reuse, and Downcycle scenarios.

FIG. 8 is an image depicting a sustainability and circularity overview of SMC barrier film evaluated by the present invention.

FIG. 9 is a process flow diagram depicting the system boundary for the illustrative example.

FIG. 10 depicts processes with normalized flows used to construct the A and B matrices in the illustrative example.

FIG. 11 is a diagram of the Superstructure Network of the life cycle of barrier films, from upstream-processes, to the down-stream end-of-life processes.

FIG. 12 is a graphical depiction of the Client-Server model for the software tool.

FIG. 13 is a mock-up of TranZero-Barrier Film's interface showcasing its key features

FIGS. 14 A1-14 A2, 14 B1-14 B2, and 14 C1-14 C2 are graphical representations of the results of the single-objective optimization for (A) minimizing global warming potential (GWP), (B) maximizing circularity, and (C) minimizing cost.

FIGS. 15A and 15B are graphical representations of the results of the multi-objective optimization represented as a Pareto frontier.

FIGS. 16A-16C depict box-and-whisker plots of multi-objective optimization results across all uncertainty scenarios, with (A), (B), and (C) representing the distribution of results for the GWP, circularity, and cost objectives, respectively.

FIGS. 17A-17C are images of the user interface of the Scenario Analysis section of TranZero-Barrier Film Version.

FIGS. 18A-18C are other images of the user interface of the Scenario Analysis section of TranZero-Barrier Film Version.

FIG. 19 is a block diagram of a computer-implemented system suitable for implementing the multilayer barrier film sustainable circular economic analysis and design method according to embodiments disclosed herein.

Corresponding reference characters indicate corresponding elements among the view of the drawings. The headings used in the figures do not limit the scope of the claims.

### DETAILED DESCRIPTION

In some aspects, the techniques described herein relate to a system for analyzing and designing sustainable and circular economies for plastic waste products, including: a memory; and a processor in communication with the memory, wherein the processor is operable to execute a set of instructions located on the memory to generate an optimized sustainable and circular economy using a plurality of end-of-life technologies for a process that produces a waste material by: defining an objective function for each of an environmental impact indicator, a circularity indicator, an economic indicator, and a resilience indicator; wherein the objective functions are based on a plurality of technology matrices for a plurality of input-output relationships between a plurality of products, processes, and technological flows, a plurality of intervention matrices for a plurality of environmental flows emitted or consumed for each process of the technology matrices, and a scaling vector; for each end-of-life technology of the plurality of end-of-life technologies, performing a multi-objective optimization by: solving a series of single objective optimizations, each corresponding to an individual objective function, wherein all remaining objective functions are used as threshold value constraints on the optimizations; systematically varying the threshold values of the remaining objective functions to identify the optimized sustainable and circular economy for the process when employing each end-of-life technology.

In some embodiments, the techniques described herein relate to a system, wherein the multi-objective optimization is further performed by: introducing a penalty variable and slack parameters while solving the series of single objective optimizations.

In one embodiment, the techniques described herein relate to a system, wherein the resilience indicator acts as a constraint of the multi-objective optimization.

In one aspect, the techniques described herein relate to a system, wherein the objective function for the environmental impact indicator estimates an environmental impact by estimating a resultant flow of materials having an environmental impact for the process when employing the plurality of end-of-life technologies.

In some embodiments, the techniques described herein relate to a system, wherein the objective function for the circularity indicator estimates a degree of economic circularity by estimating a quantity of raw material consumed, a quantity of waste material generated, and a quantity of total product manufactured by the process when employing the plurality of end-of-life technologies.

In some embodiments, the techniques described herein relate to a system, wherein the objective function for the circularity indicator accounts for a quantity of recovered waste material that is utilized as raw input material for a secondary process.

In some embodiments, the techniques described herein relate to a system, wherein the objective function for the economic indicator estimates a total supply chain cost for the process when employing the plurality of end-of-life technologies by isolating cost variations in a downstream phase and an end-of-life phase of the process.

In some embodiments, the techniques described herein relate to a system, wherein the objective function of the resilience indicator is optimized only for flows in the process directly related to raw material inputs, a manufactured product, and the waste material.

In some embodiments, the techniques described herein relate to a system, wherein an uncertainty factor is applied to the multi-factor optimization to account for the uncertainty across the plurality of technology matrices, the plurality of intervention matrices, and a demand for a manufactured product.

In further embodiments, the techniques described herein relate to a system, wherein the processor is further operable to: compare the optimized sustainable and circular economy for each of the end-of-life technologies to determine an overall optimized sustainable and circular economy for the process.

In yet other embodiments, the techniques described herein relate to a system, wherein the processor is further operable to: recommend a plan for achieving the optimized sustainable and circular economy for the process.

In further embodiments, the techniques described herein relate to a system, wherein the processor is further operable to receive an optimization goal, wherein the multi-objective optimization prioritizes the optimization goal while identifying the optimized sustainable and circular economy.

In some aspects, the techniques described herein relate to a method for analyzing and designing sustainable and circular economies for plastic waste products, including: defining an objective function for each of an environmental impact indicator, a circularity indicator, an economic indicator, and a resilience indicator; wherein the objective functions are based on a plurality of technology matrices for a plurality of input-output relationships between a plurality of products, processes, and technological flows, a plurality of intervention matrices for a plurality of environmental flows emitted or consumed for each process of the technology matrices, and a scaling vector; for each end-of-life technology of a plurality of end-of-life technologies: solving a series of single objective optimizations, each corresponding to an individual objective function, wherein all remaining objective functions are used as threshold value constraints on the optimizations; and systematically varying the threshold values of the remaining objective functions to identify an optimized sustainable and circular economy for a process that produces a waste material when employing each end-of-life technology; and generating an optimized sustainable and circular economy for the process by comparing the optimized sustainable and circular economy for each of the end-of-life technologies to determine an overall optimized sustainable and circular economy for the process.

In further aspects, the techniques described herein relate to a method, wherein the resilience indicator acts as a constraint of solving the series of single objective optimizations and systematically varying the threshold values to identify the optimized sustainable and circular economy.

In some embodiments, the techniques described herein relate to a method, wherein the objective function for the environmental impact indicator estimates an environmental impact by estimating a resultant flow of materials having an environmental impact for the process when employing the plurality of end-of-life technologies.

In some embodiments, the techniques described herein relate to a method, wherein the objective function for the circularity indicator estimates a degree of economic circularity by estimating a quantity of raw material consumed, a quantity of waste material generated, and a quantity of total product manufactured by the process when employing the plurality of end-of-life technologies.

In further aspects, the techniques described herein relate to a method, wherein the objective function for the economic indicator estimates a total supply chain cost for the process when employing the plurality of end-of-life technologies by isolating cost variations in a downstream phase and an end-of-life phase of the process.

In some embodiments, the techniques described herein relate to a method, wherein the objective function of the resilience indicator is optimized only for flows in the process directly related to raw material inputs, a manufactured product, and the waste material.

In some aspects, the techniques described herein relate to a method, further including: recommending a plan for achieving the optimized sustainable and circular economy for the process.

In some embodiments, the techniques described herein relate to a method, further including receiving an optimization goal, wherein the series of single objective optimizations are solved while prioritizing the optimization goal.

The present disclosure relates to systems and methods for analysis and design software that enables a circular economy of multilayer plastic barrier films used in SMC production. The systems and methods disclosed herein address challenges in the end-of-life (EOL) recovery of multilayer plastic films and assesses the sustainability and circularity of various EOL strategies. Furthermore, the sustainability aspects of SMC film, as well as multilayer plastic films in general, have not undergone thorough investigation. Rather, previous studies have primarily focused on the environmental sustainability of multilayer films without considering the economic viability of alternative EOL processes. The present disclosure on the other hand, endeavors to offer a comprehensive assessment of the sustainability of SMC film by considering circularity, environmental impacts, and economic viability in a cohesive manner. Finally, an optimization approach is used to identify the best combination of EOL solutions to treat multilayer films. This approach enables stakeholders to gain insights into the diverse array of solutions along with associated sustainability trade-offs.

### INTRODUCTION

Sheet molding composites have a global market size of USD 2.1 billion in 2020 and are usually processed with multilayer barrier/carrier films to prevent emissions from volatile organic compounds (VOC). The plastic barriers are separated from SMC after the curing process and discarded. To illustrate the high consumption volume of SMC barrier/carrier films, Kohler Co., a company which uses SMC in their bath and showering product lines, alone generates over 1M lb/year of SMC barrier/carrier film waste. Therefore, high amount of SMC barrier/carrier film plastic waste creates a great opportunity for reusing, recycling, or valorization at its end of life. This can be achieved through transition from a linear to a circular supply chain design. However, this transition will not be feasible without overcoming the technical and economic barriers. The present disclosure aims to tackle this by making the film economy circular. Different end of life alternatives are evaluated experimentally and disclosed herein. The reusability of the film has been studied through applying different mechanical and solvent cleaning techniques. The operability concerns regarding the utilization of the cleaned film for long run operations were addressed by thermally stitching the film. Pelletizing of the cleaned film has also been investigated as a viable technique for recycling or downcycling of the film as molded products. In addition to technical barriers, designing a sustainable circular supply chain for SMC carrier film products requires uncovering the collaboration opportunities between suppliers and users at different stages of the value chain to expand its use to other products. These opportunities are investigated herein by finding companies willing to buy or treat plastic film waste. Finally, the economic viability and environmental impacts of these circular design alternatives are evaluated through techno-economic assessment (TEA) and life cycle analysis (LCA). Techno-economic and life cycle inventory data for various pathways are also made available as one of the main outcomes of the present disclosure. Preliminary LCA results indicate that the current SMC film supply chain (base case) emits 5.81 tonne CO2 eq. and consumes 104 GJ energy per tonne of SMC film. It is estimated that alternative circular pathways result in 14-20% less CO2 emissions and 34-44% reduction in embodied energy.

Two case studies are disclosed herein which evaluate the possibility and ways to recycle multilayer polymer films for the first time, as presently, there are no studies evaluating circular and sustainable EoL alternatives for SMC barrier/carrier films. The first case study is directed to how (1) the thermodynamic incompatibility of nylon and PE and (2) the presence of contaminations will affect treatment techniques. This case study was performed with the purpose of enabling the employment of unique recovery strategies for SMC barrier/carrier film supply chains. More specifically, in the first case study process, life cycle and cost data modules are provided for the current (conventional) and alternative SMC barrier/carrier film supply chains and emerging technologies for treating, recovering, and recycling SMC barrier/carrier film waste are evaluated. The effect of the alternative EOL treatments are studied on the value chain and from a customer preferences point of view life cycle and techno-economic analyses are performed to evaluate environmental impacts and economic performance of the current and emerging technologies for EoL processes.

The second case study is directed to Polyethylene (PE)-Polyamide (PA) films utilized in the SMC production line at Kohler Co. Two experimental scenarios were explored: one involving pelletization and injection molding of PE-PA films for making secondary products (a type of bracket used internally at Kohler), and another examining the reuse potential by employing mechanical and solvent cleaning techniques to remove contaminants. Additionally, three EoL treatment scenarios were considered, encompassing incineration, pyrolysis, and solvent-based recycling, with data sourced from technology vendors and literature. A holistic life cycle assessment (LCA) and techno-economic analysis (TEA) were conducted to establish an end-of-life superstructure, optimizing the multilayer film supply chain for a net-zero, sustainable circular economy. Results indicated a tradeoff between circularity maximization and greenhouse gas (GHG) emissions minimization. The reuse scenario exhibited the highest circularity (48%), while the solvent-based recycling scenario achieved the lowest GHG emissions (82% reduction compared to the base case). Moreover, system boundary expansion in recycling and reuse scenarios highlighted the dependence of LCA and TEA results on the number of recycling trips and the ultimate end-of-life for the final products, emphasizing the need for system expansion and rigorous LCA of plastic waste.

To address these problems, a software tool is disclosed herein to assess and design a resilient and sustainable circular economy for SMC barrier films. The tool functioned to analyze the circularity and sustainability of hundreds of combinations of alternatives in different life cycle stages and is further adaptable for the inclusion of other plastics and chemicals in future versions. Users of this tool can choose the best combination among these alternatives with respect to the selected economic, environmental and circularity objectives.

To achieve this goal, it is important to understand and solve different challenges.

### Case Study #1

### SMC Barrier Film Supply Chain

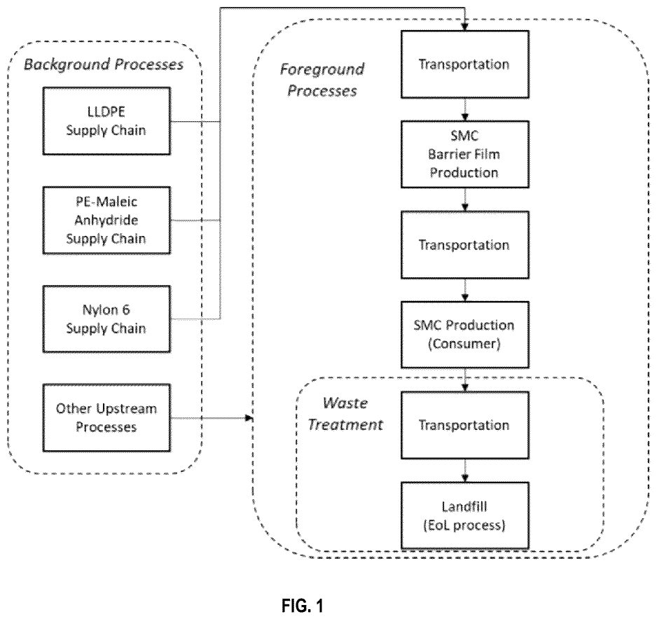

FIG. 1 shows the current (conventional) SMC barrier/carrier film supply chain, from extraction of resources to the EoL treatment of SMC film after consumption. The composition of the film is obtained from Berry Global Co. The film is composed of linear low-density polyethylene (LLDPE), nylon 6, and polyethylene grafted with maleic anhydride (PE-maleic anhydride), which acts as an adhesive linking the core polyamide layer to the top and bottom LLDPE layers. Foreground process data are obtained from Kohler Co. and Berry Global Co. Kohler is one of the major manufacturers of SMC for bath and showering products which makes them one of the largest consumers of SMC barrier/carrier films. Kohler generates 1 lb M/yr of SMC film waste and discards it to landfill. The generated waste is sent directly from Kohler site to an unsanitary landfill by a waste management company. Accordingly, landfilling was assumed as the only waste treatment option in the conventional supply chain of multilayer SMC barrier/carrier film generated in the US.

### Life Cycle Assessment

A cradle-to-grave life cycle assessment (LCA) is performed to evaluate the environmental impacts of the current SMC film supply chain. The LCA wis performed according to the standard ISO 14040/14044. The system boundary is shown in FIG. 1. Instead of considering unit process data for LLDPE, nylon 6, and PE-maleic anhydride, the whole life cycle supply chain of these processes is considered for the LCA to capture the system-wide environmental impacts of the consumption of virgin feedstock. Inventory data for foreground processes are obtained from industry (Kohler and Berry Global). Ecoinvent v3.8 is used for obtaining inventory data for the background processes. US data are used whenever available. Otherwise, global or rest of the world data (RoW) are used.

TRACI is used to transform inventory data to the following impact categories: acidification, ecotoxicity, eutrophication, global warming, photochemical oxidation, human health (carcinogenics and non-carcinogenics), and respiratory effects. Cumulative exergy demand is used to quantify the cumulative exergy inputs to the system, which represents the total resource consumption.

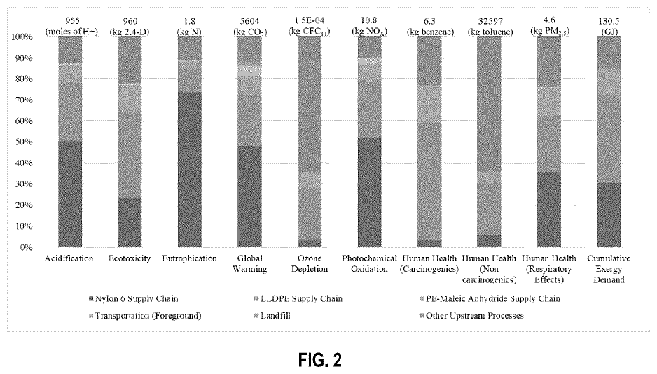

Cradle-to-grave LCA results are presented in FIG. 2. The results show that raw material supply chains (nylon 6, LLDPE, and PE-maleic anhydride) have considerably larger life cycle impacts compared to other upstream and foreground processes. This indicates that the consumption of virgin material is the main contributor to the negative environmental impacts in the SMC barrier/carrier film supply chain. Recycling/recovering strategies can reduce the primary feedstock consumption and/or increase the consumption of secondary feedstock, which can eventually reduce the environmental impacts. This is discussed in the alternative pathways for EoL management of SMC films section.

Moreover, using the REMADE estimator tool for calculating the cradle-to-grave global warming potential and energy consumption of the base case, it is estimated that the base case emits 5.82 CO2 eq. and consumes 104 GJ energy per tonne of SMC barrier/carrier film, which is comparable to the LCA results obtained for the base case (with global warming potential of 5.6 kg CO2 eq. and cumulative exergy demand of 130.5 GJ).

### Techno-Economic Analysis

Techno-economic analysis (TEA) provides an understanding of how individual cost and other factors influence a process' overall costs and the product's minimum selling price (MSP). To date, baseline TEA models of barrier/carrier film production and of SMC production have been completed; TEA data and results for the barrier/carrier film production are presented here. The baseline TEA model was developed to correspond as closely as possible to the current production process of SMC barrier/carrier film and applied to calculate the barrier film MSP, which was found to be within 0.10 USD/lb of the actual purchase cost. Financial inputs and assumptions used in the TEA model are listed in Table 1, with key results provided in Table 2.

TABLE 1
Financial assumptions used in the baseline TEA
model of barrier/carrier film production.

| Parameter | | Value and | | |
|---|---|---|---|---|
| Category | Parameter | Units | | Source |
| Materials | Polyethylene resin cost | 0.9 | USD/lb | [24] |
| | Polyethylene resin | 700 | lb/hour | Berry Global |
| | consumption | | | |
| | Nylon-6 cost | 1.7 | USD/lb | [24] |
| | Nylon-6 consumption | 300 | lb/hour | Berry Global |
| Energy | Power Use | 50 | kW | [25] |
| Labor | Plant employees | 4 | | |
| Capital | Blown film extruder cost | $200,000 | | Industrial |
| | (200 lb film/hour capacity) | | | References |
| | Plant depreciation period | 7 | years | [26] |
| | Plant lifetime | 30 | years | [26] |
| | Discount rate | 10% | | [26] |
| Operations | Film reject rate | 10% | | Berry Global |
| | On-stream factor | 90% | | Berry Global |
| Output | Film width | 1000 | mm | Kohler |
| | Film thickness | 0.1 | mm | Kohler |

| | | |
|---|---|---|
| Film production | 1000 lb film/hour | Berry Global |

TABLE 2
Summary of baseline TEA results for barrier film production.

| Direct Materials | 9.0 × 10⁶ | USD/year |
|---|---|---|
| Energy | 3.9 × 10⁶ | USD/year |
| Direct Labor | 9.5 × 10⁵ | USD/year |
| Capital | 8.5 × 10⁵ | USD/year |
| Waste | 9.0 × 10⁵ | USD/year |
| Final Barrier Film Cost | 2.10 | USD/lb |

Although this baseline TEA model does not include circular EoL options, knowing the parameters that influence the current barrier film production process economics will enable direct financial comparisons of EoL options that could change the material input types, amounts, or costs, valorize or reduce waste streams, and/or change the energy requirements of barrier film production.

### Alternative Pathways for EoL Management of SMC Films

### Experimental Results

The initial approach was to investigate if Kohler would reuse the reclaimed/cleaned film. It appears that this alternative may not be feasible as the film is cut when making SMC thus the reclaimed film would be much shorter than the original film. The long operation time in manufacturing the SMC is to balance the SMC machine, thus once balanced the operation should continue without interruption even if manufacturing a slightly different SMC formulation. It is believed this can also be applicable to other SMC manufacturers that operate in continuous mode. Nevertheless, those SMC manufacturers that run in a batch mode would still be willing to use shorter film rolls.

A targeted solvent cleaning technique was used to remove the styrene monomer contaminations on the surface of the film without dissolving PE polymers. Diacetone alcohol is one of the most common solvents used to remove cured polyester resins and does not dissolve PE. Preliminary results indicate that the solvent, diacetone alcohol, has good potential for cleaning the film. Also, preliminary evaluations indicate that for the reuse scenario to be environmentally less harmful than the base case scenario, the mass ratio of solvent to the film must not exceed 1:1, and the solvent should be used several times and recovered as much as possible.

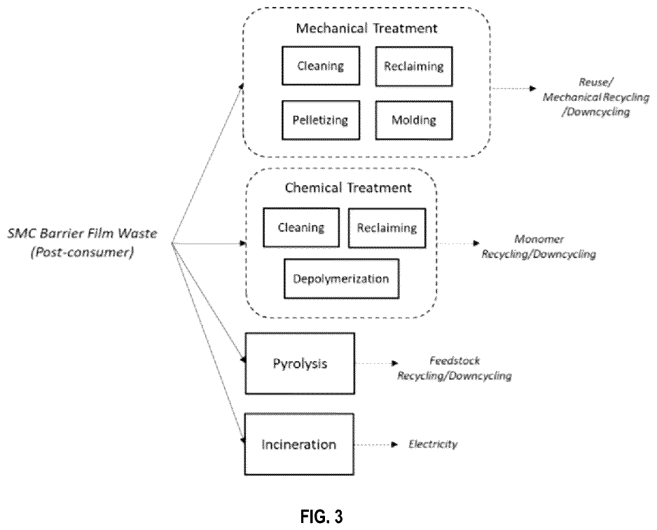

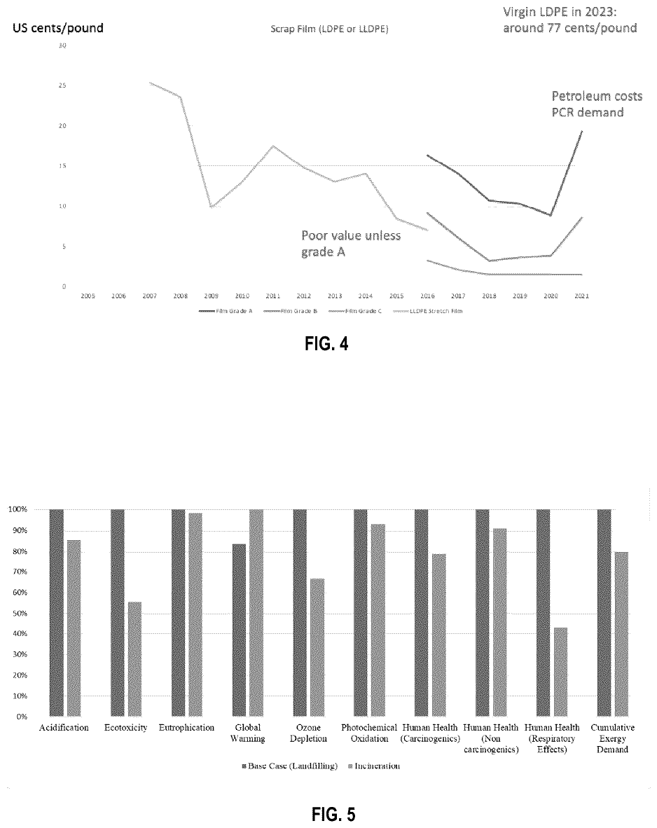

Pelletizing the film with and without the cleaning step is currently under investigation. These pellets could subsequently be recycled for reproducing the SMC barrier/carrier film (referred to as mechanical recycling in FIG. 3) or will be used to produce other products through the molding process (referred to as downcycling scenario in FIG. 3). Chemical recycling and pyrolysis will also be studied after evaluating the above-mentioned scenarios.

### Value Chain and Customer Preference

Any recycling solution for the barrier film waste generates recycled content that must be reprocessed internally or sold on the scrap plastic market. The data below shows the price of recycled LDPE, the most common thin film, across different grades. Through most of the time it is seen that the value of r-LDPE has decreased. In 2020 though, prices of higher-grade r-LDPE spiked. In part this was due to the increased cost of virgin plastic, due to increased petroleum prices and supply shortages due to the pandemic. But part of this increase was also due to the unprecedented increase in demand for recycled plastic content, linking to the commitments that brands are making for 100% recyclable, reusable, or compostable plastic packaging by 2025.

There are a variety of downstream markets for this r-LDPE. There is growing demand from the construction and building sector for recycled plastic as both a product or filler. For example, rail ties, lumber, and sheets can meet functional requirements with recycled plastic content. Roof cover board and subflooring are applications with the least material restrictions; other applications may have limitations due to chemical exposure. The Material Recovery for the Future project created a flexible bale consisting of 3-7 plastic and was able to show that there was economically viable demand for a bale made of recyclable flexible film.
Can use 100% recycled thin film: Roof coverboard and subflooring, Pallets, Sheet stock for signage, Fuels or petrochemicals
Can use a percentage as recycled thin film: Rail ties, Lumber, Trim, Industrial mats, Tanks, pipes, and containers, Bottles, Crates, Durable goods, Cinder blocks
Can use up to 3% plastic: Asphalt binder

### Life Cycle Assessment

Among different EoL alternatives, the life cycle impacts of the incineration scenario were evaluated and compared it with the base case (landfilling) by conducting a cradle-to-grave LCA. Ecoinvent v3.8 database is used for the incineration scenario; “treatment of mixed plastic waste, municipal incineration” were considered and an electric energy recovery of 3.92 MJ/kg of film was assumed (as stated in the database for mixed plastic waste). It is also assumed that the electricity produced from the incineration process will substitute the market mixed electricity in the US. Results of the comparative LCA are presented in FIG. 5.

As presented in FIG. 5, for all impact categories except global warming potential, incineration scenario will have less environmental impacts compared to the base case (landfill) due to the generation and substitution of electricity. However, the incineration scenario will result in higher global warming potential compared to the base case because of the large amount carbon dioxide emitted from the incineration process. More specifically, the LCA results indicate that the incineration scenario emits 16% more CO2 eq. and demands 20% less cumulative exergy compared to the base case scenario. This shows the environmental tradeoff between global warming potential and other life cycle impacts in the incineration scenario. For other alternative EoL processes (reuse, recycling, downcycling, and pyrolysis), experimental results and/or literature data for conducting comparative LCA will be used, which will be provided in the future.

In addition, REMADE estimator is used to estimate the potential reduction in global warming potential and energy consumption by applying recycling/recovering strategies; it is estimated that this could result in 14-20% less CO2 eq. emissions and 34-44% reduction in the embodied energy compared to the base case scenario.

### Developing a Tool for Analyzing and Designing a Sustainable Circular Economy

The sustainable circular economy (SCE) framework was formulated and developed in previous work and was used to develop the presently disclosed tool for analyzing hundreds of combinations of different alternatives for EoL treatment of SMC barrier/carrier films and designing the “best” sustainable circular supply chain. Multiple environmental, economic, and performance-based objectives can be considered and formulated as a multi-objective optimization problem which is solved using different multi-objective optimization techniques that can generate compromised solutions.

### Conclusions & Recommendations

SMC barrier/carrier films are multilayer PE-nylon plastic films that are widely used in the manufacturing of SMC products. Currently, the film is removed before the molding process and is discarded to landfill. However, due to the high production rate of SMC products, the rate of the plastic film waste generated is significantly high, which can cause many environmental burdens and create opportunities for recovering the waste at its end of life. The present work focuses on revealing these opportunities and evaluating alternative pathways for treating the SMC barrier/carrier film plastic waste. Preliminary results show that reducing this waste by applying circular strategies can lead to 14-20% and 34-44% reduction in global warming potential and embodied energy, respectively. More insights on the environmental tradeoffs will be provided once we evaluate all the alternative scenarios. Moreover, in this disclosure, some of the technical, environmental, and economic challenges of various alternatives are discussed and compared to the base case scenario (landfill disposal). Value chain and customer preference aspects are also studied in order to enable circular strategies at different stages of the life cycle. By considering all aspects of circularity and sustainability, different environmental, economic and performance tradeoffs will be identified for all alternative circular scenarios. Accordingly, the presently disclosed software tool has been developed to find the “best” or “compromised” sustainable circular solution for SMC barrier/carrier films. Multi-objective optimization methods are used by the tool to generate optimum solutions for different sustainability, circularity, and performance objectives. Finally, the tool can be extended to cover other (plastic) products, specifically multilayer plastic films used in other industries such as food packaging.

### Case Study #2

Now looking to the second case study, a more robust analysis of various EoL product recovery methods is disclosed and utilized to further develop the present invention. As stated previously, the disclosed solution to the above plastic dilemma lies in transitioning from a linear to a circular economy. Circular economy strategies, which emphasize product recovery at its end of life (EOL), can mitigate waste generation, reduce resource consumption, and limit greenhouse gas emissions. This transition requires adopting sustainable alternatives throughout the lifecycle of each distinct plastic product.

Among different plastic products, plastic films are a prominent group widely used in different industries. There are two main groups of plastic films, namely monolayer and multilayer plastic films. Monolayer plastic films are one-layer plastic material made of one type of polymer (polyethylene (PE), polypropylene (PP), polyamide (PA), etc.). On the other hand, multilayer films are made of multiple types of polymers in a co-extrusion process. With a consumption rate of 100 billion pounds per year, multilayer films play a major role in various industries due to their barrier and carrier properties. Despite their counterparts, multilayer films are not conventionally recycled at their EOL due to their heterogenous structure. A circular economy implementation for multilayer films requires overcoming technical obstacles caused by thermodynamic immiscibility of different types of polymers in its structure. Moreover, adopting a circular economy approach to recover multilayer films can provide valuable insights into how to recycle difficult-to-process polymers like nylon as well as heterogenous polymer mixtures that pose post-consumption sorting difficulties, such as nylon mixed with other types of resins.

The study involved conducting experiments on this specific type of waste, followed by a comprehensive sustainability assessment. This assessment included life cycle analysis, circularity analysis, and techno-economic evaluation to gauge the sustainability of multilayer films used in Sheet Molding Compound Process, which are referred to as SMC film. The ultimate goal was to create a user-friendly software capable of assessing materials and flows throughout the SMC film supply chain network. The software aims to evaluate various factors such as cost, emissions, circularity, and performance associated with different EOL strategies such that these outcomes can be compared with the conventional SMC film supply chain. This software, designed for decision-making, holds the potential to contribute to achieving a net-zero, sustainable, and profitable circular economy. Furthermore, the software's scope can be expanded to encompass other product systems within the material and chemical industry.

### Technology Approach

### Experimental Work

Two experimental routes for treating SMC films are evaluated. In one approach, the contaminations on the film are removed using a mechanical and solvent cleaning (MASC) technique. The subsequent film can be reused for the same purpose. Nevertheless, there are practical concerns regarding reusing the film at Kohler, which operates as a continuous process. This is because the film is no longer in a continuous rolling form. Therefore, an alternative approach is to use the cleaned SMC film in SMC manufactures operating in batch mode. The experimental results for treating two different samples using this approach are presented in Table 3.

TABLE 3
Experimental results for the mechanical
and solvent cleaning process

| Initial Film | Film Weight | Virgin Film | Solid Weight | Solid |
|---|---|---|---|---|
| Weight | after 1 | Weight | after | Removed |
| with Solid (g) | Pass | (g) | Cleaning (g) | (%) |
| 43.35 | 37.30 | 32.06 | 5.24 | 53.6 |
| 72.7 | 45.2 | 32.06 | 13.14 | 67.7 |

Following five passes of one sample, nearly all impurities are successfully removed. The calculated solvent requirement for this process, considering five wash cycles, amounts to 5.56 kg per kg of SMC film waste.

In the second approach, the SMC film waste is pelletized and is mixed with virgin PP to make injection-molded products. One specific product of this category is brackets used to hold the bathtubs during their use phase. An industrial partner, Kohler, expressed concerns regarding the availability of sufficient SMC film and were interested in its potential combination with virgin PP due to practical constraints. Kohler sought experimental confirmation to ensure that such a combination would not yield detrimental effects. Similar verification was previously undertaken at Kohler's request to ensure that properties remain within acceptable limits. Currently, Kohler utilizes 100% virgin PP for bracket production. The practical aim of this investigation was to explore the feasibility of reducing virgin PP usage while maintaining desired product properties. Table 4 provides information on the mechanical properties of brackets manufactured from film waste, black PP, and a mixture of PP and film waste. The results indicate that incorporating virgin PP into the blend can enhance the mechanical properties of the injection-molded products produced from the recovered pellets. Employing 25% SMC film in the composition did not have a detrimental effect on the bracket mechanical properties. Nevertheless, the ratio of film waste to virgin PP depends on 1) the amount of film waste available and 2) the mechanical properties of the final product. It was concluded that a 25:75 ratio of film waste to virgin PP is a practical ratio. Nevertheless, using such approach in other industrial settings or making other types of byproducts requires further experimental investigation for that specific process.

TABLE 4
Mechanical properties of brackets produced from virgin
PP, recovered pellets, and a mixture of both.

| | Tensile Strength | |
|---|---|---|
| Pellets composition | (MPa) | Tensile Modulus |
| 100% Film Waste | 19.71 ± 1.81 MPa | 629.7 ± 25.7 |
| 100% Black PP | 22.04 ± 0.25 | 1755 ± 22.0 |
| 25% Film Waste + 75% | 18.43 ± 0.12 | 1316 ± 72.6 |
| Black PP | | |

### Sustainability Analysis

A life cycle, circularity, and techno-economic assessment were performed to assess the sustainability aspects of SMC film supply chain. The sustainability assessment was performed for the following scenarios:

Linear Economy (Business As Usual): This is the base case scenario, where the film is landfilled after use. The supply chain data for this scenario are obtained from Kohler and Berry Global.

Reuse: In this scenario, the film is introduced to a mechanical and solvent cleaning (MASC) process after use. The film is washed with diacetone alcohol to remove the remaining contaminations from SMC manufacturing. The film can be reused for the same application or be sent to another SMC manufacturing facility for use. The experimental results presented in the previous section are used to model this approach.

Recycle: In this scenario, the film is treated by solvent targeted recovery and precipitation (STRAP) process, and PE and PA are separated from each other. The separated resins can be recycled to the manufacturing process to remake the SMC film or can be exported to different production systems as pure PE and PA streams. Literature data for the separation process of PE-PA film using the STRAP process were used.

Downcycle: In this scenario, the film waste is pelletized and mixed with polypropylene to make lower-quality pellets. These pellets can be used to make injection-molded products. One such product is the bathtub brackets produced internally at Kohler. The brackets were previously produced from 100% virgin polypropylene. However, the recovered pellets can now be used to make these brackets. Process input and output data were obtained from an experimental team and are used to model this scenario.

Pyrolysis: In this scenario, it was assumed that the SMC film can be subjected to the pyrolysis process. In this process, pyrolysis oil is produced which can be sold as fuel grade oil. Literature data was used to model this approach.

Energy Recovery: In this scenario, the film waste is incinerated, and as a result, electricity can be produced. Ecoinvent database for incineration of mixed plastic waste was used to model this scenario.

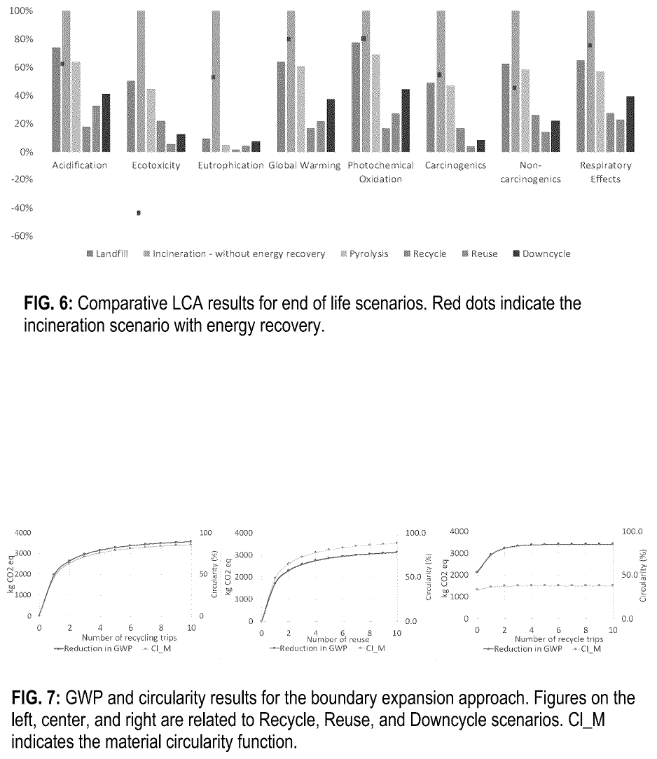

A cradle-to-grave comparative life cycle analysis was performed, and the results are demonstrated in FIG. 6. The LCA is performed using the ISO standard for environmental impact assessment. Ecoinvent v3.8 database was used for the upstream supply chain data, and real industrial data was obtained from Kohler and Berry Global when data was available. TRACI from the US Environmental Protection Agency (EPA) was used as the impact assessment method. A substitution approach was used to deal with the environmental impacts of the EOL processes and their byproducts. In this approach, the environmental burden of the recycling process is taken into account but the environmental credits achieved by the byproduct substituting virgin material to produce the same product is also considered.

Results indicate that the Recycle (STRAP) scenario outperforms other scenarios in most environmental impact categories, including Global Warming Potential (GWP). The Reuse scenario (MASC) has slightly higher GWP compared to the Recycle scenario, but it performs better in some other impact indicators, i.e., human health impacts. Overall, the material recovery scenarios, i.e., Reuse, Recycle, and Downcycle, perform better compared to the energy recovery scenarios (pyrolysis and incineration).

In addition to the LCA, a circularity analysis was performed to determine the circularity level of each scenario. For this, the Ellen McArthur Foundation's Material Circularity Indicator for SMC films was tailored. The new metric is capable of distinguishing the quality of the recycled product by introducing a quality parameter to the metric. The quality parameter is the ratio of the monetary value of EOL product in a specific circularity scenario over the monetary value of the main product. The circularity results are presented in Table 5.

TABLE 5
Circularity results for different end of life strategies

| | Linear | Energy | Pyrol- | | | Down- |
|---|---|---|---|---|---|---|
| | Economy | Recovery | ysis | Recycle | Reuse | cycle |
| Circularity | 0 | 0.4 ^{a} (0 b₎ | 1.7 | 11.6 | 47.5 | 10.6 |
| (%) | | | | | | |

^{a} with energy recovery
b: without energy recovery

Results indicate that the Reuse scenario has the highest circularity followed by the Recycle and Downcycle scenario.

Due to using the substitution approach, the LCA and circularity results are highly dependent on the model assumptions and the system boundary. Essentially, in the substitution approach, crucial factors such as the number of recovery trips a product can undergo or the impact of the final waste after recovery and the ultimate use of the product are not taken into consideration. In the substitution approach, these aspects are not included since the product leaves the system boundary after the EOL process. Therefore, to perform a robust life cycle and circularity assessment, the physical and temporal boundary of the system were expanded to account for multiple life cycles and ultimate end of life of a product when it is not recyclable anymore. This was performed for the Reuse, Recycle, and Downcycle scenarios. The focus was GWP and circularity, and the results are presented in FIG. 7.

Results indicate that with increasing the number of recycling or reuse trips for the EOL product, climate change and circularity impacts are improved. This is because more virgin material is substituted in multiple life cycles. Nevertheless, after a certain number of recovery trips, a plateau region is reached. This is because the effect of substituting the virgin material fades away since its effect gets very small compared to other major factors contributing to GWP. In other words, most of the virgin material has already been substituted, and a result, the substitution effect becomes minimal. This type of analysis is very useful for comparing different recovery strategies when the effect of number of recovery trips and ultimate end of life of a product is significant. For instance, in the case that the byproduct of the Recycle, Reuse, and Downcycle scenarios is only 2 times recoverable, the GWP savings from the Downcycle scenario would be higher. This is in contrast with the substitution approach, where the Recycle scenario had the lowest GWP. Therefore, by accounting for the number of recovery trips and ultimate end of life process, circularity and life cycle impacts can change.

Techno-economic analysis (TEA) is a systematic accounting for all costs involved in constructing, operating, and maintaining a production technology, with the goal of calculating a minimum selling price (MSP) for the technology's primary product. TEA can be applied to a broad range of technology types and, if consistent financial data and assumptions are used, results in a straightforward comparison of each technology's economic performance. When both TEA and LCA are applied to the same system, trade-offs between economic and environmental performance can be identified and quantified, along with any synergistic situations that are both economically and environmentally advantaged. The TEA models in this work were all built using a TEA template, a consistent set of input data and calculations that was developed separately and then populated with process-specific data for each EOL technology. Using a template assured that all EOL technologies can be evaluated fairly and compared on the same basis, even the technologies which are still being developed at the lab scale. The process-specific data used to populate the TEA model template is kept updated as technology development continues and, for instance, energy and material efficiency improves. Identical financial assumptions were used for all technologies. These include per-unit material and utility costs, capital costs for unit operations used in multiple technologies, rent, insurance, contingency, and other soft costs. The process scale for all technologies was assumed to be the same and was based on the scale of existing commercial-scale processes for barrier film and SMC production. Labor requirements—the number of workers and supervisors, and the labor burden multiplier—were assumed to be the same across all technologies. The technologies were distinguished by the quantity and types of material and energy inputs required, the amount of revenue generated by any co-products, and the number and type of unit operations required. The economic metrics calculated from the TEA models are used to compare individual EOL technologies as well as entire EOL supply chains. The supply-chain-scale metric presented here, total EOL cost, is a single-number economic summary of the EOL supply chain. Total cost is normalized by the functional unit amount and is used to directly compare the costs associated with different EOL supply chain configurations. Total EOL cost is also combined with circularity metrics and environmental impacts for multi-objective optimization of EOL supply chains. While total EOL costs exclude the costs associated with producing SMC from either virgin or secondary barrier film, these costs can be included when relevant to the analysis.

TABLE 6
Total EOL cost (USD) for 1 metric ton of barrier film.

| | | Total EOL Cost |
|---|---|---|
| EOL Process | Primary Product | (USD/metric ton) |
| Landfilling | None (landfilled waste) | 3,176 |
| Incineration | Electricity | 3,658 |
| Pelletizing | Plastic granulates | 3,575 |
| Pyrolysis | Liquid fuel | 4,501 |
| STRAP | Polyethylene | 3,273 |
| MASC | Secondary barrier film | 25,962 |

Preliminary results comparing the EOL technologies assessed in this work are given in Table 6. Landfilling the barrier film at EOL is currently the cheapest option, as the only cost associated with landfilling is the tipping fee. STRAP, pelletizing, and incineration are the three next most expensive options. Although more capital- and materials-intensive than the other two, STRAP remains relatively low-cost due to the production of both polyethylene and nylon as valuable co-products and a very high solvent recovery rate, i.e., 99.8%. Pyrolysis and MASC are the two most expensive options, with MASC being by far the most expensive. MASC is one of the EOL technologies that is currently being developed at lab scale, and the high costs are due to the use of large quantities of cleaning solvent required to restore EOL barrier film to a useful state. A lower solvent recovery rate compared to STRAP (80% versus 99.8%) is also contributing to the high EOL cost associated with this process. MASC costs can be expected to decline drastically both as the process is further developed and as it is scaled up, or by using more efficient solvents and more efficient ways for solvent recovery.

### Software Tool

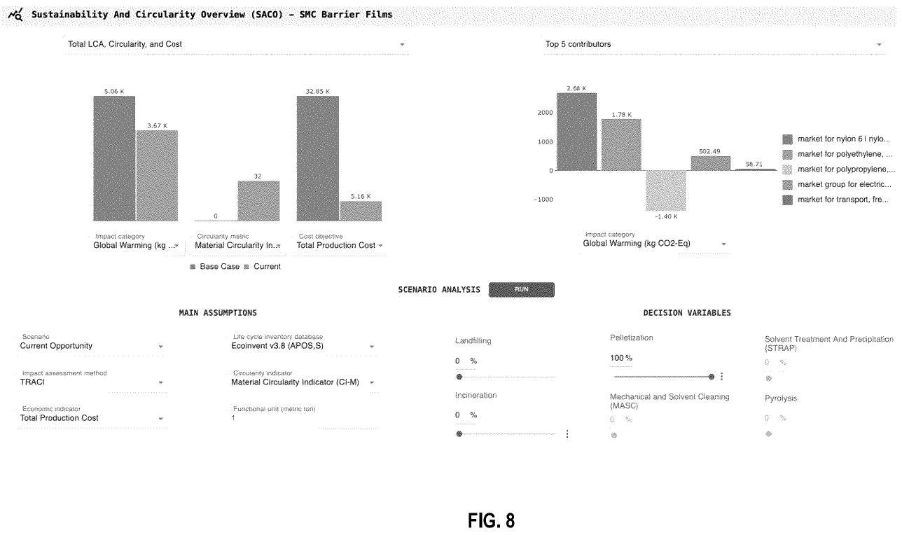

A web-based software tool has been developed to evaluate the circularity and sustainability of SMC films. The primary objective of the software is to rank EOL scenarios and devise sustainable and circular supply chains for multilayer plastic films. This tool enables the comparison of various circularity strategies for SMC films, considering their circularity, environmental, and economic impacts. The software serves as a decision-making aid by illustrating tradeoffs between different sustainability dimensions. FIG. 8 displays a screenshot of the software. The tool has the capability to generate a diverse set of figures and results, including total life cycle assessment (LCA) circularity and economic analysis results, identification of major contributors to life cycle impacts within the supply chain, Sankey diagrams, supply chain and process breakdowns for economic impacts, and more. Although initially designed for a specific product, namely SMC film, the software has the potential for expansion to assess and design sustainable and circular supply chains for any product chain

### 1. INTRODUCTION

The adoption of corporate greenhouse gas (GHG) emission reduction commitments has surged, rising from just 5% of Fortune 500 companies in the U.S. in 2019 to nearly 50% by 2024. Alongside the core priority of achieving short- and long-term emission reduction targets, circularity strategies have rapidly become an equally critical imperative. The industrial sector relies on a wide array of commodity and critical materials, many of which cannot be sourced domestically and are therefore vulnerable to price shocks and supply disruptions. Shifting from the traditional linear model of take-make-dispose to a circular economy presents a holistic solution to these challenges. Circularity can enhance industrial supply chain resilience by increasing the domestic supply of critical raw materials. Valorizing end-of-life materials and products for additional uses can lower waste disposal costs, improve resource efficiency, and keep critical materials circulating within the economy. The Circularity Gap Report 2024 sets forth a clear ambition to double global circularity by 2032.

Despite the increasing number of corporate pledges for GHG emission reduction and circularity, studies reveal that many companies are not currently on track to meet their self-imposed targets. There exist significant gaps between public declarations and concrete implementation strategies, with many firms relying predominantly on carbon offsetting rather than achieving substantive emissions reductions within their own operations. Jiang et. al highlights a 9% failure and 31% disappearance of GHG emission reduction targets. Takacs et. Al. identified company-internal barriers for circularity, such as risk aversion, economically-dominated thinking, and lack of knowledge, alongside external barriers including a lack of commercialized circularity-enabling technologies, small or nonexistent markets for recovered materials, and consumer resistance to purchasing products containing recycled or recovered materials. Despite the increased attention on circularity in the scientific literature, the actual share of secondary materials in the global economy has fallen from 9.1% in 2018 to 7.2% in 2023, signaling that pledges are not yet translating into changes.

The persistence of these gaps suggests that barriers to implementation are not only operational, but also systemic. These shortfalls largely stems from the inherent challenges of such designs. While numerous low emission and circular alternatives exist across a product's life cycle, their large-scale adoption often demands considerable capital investment and may lead to higher operational costs. Additionally, integrating GHG emission reduction and circularity strategies into supply chain design is essential to simultaneously achieve both goals in a cost-effective way, ensuring that progress in one area does not come at the expense of the other.

In addition, focusing on a single, critical metric such as cost or emission reduction can lead to selecting an optimal scenario that can cause over-reliance on key processes which increases the supply chain's vulnerability to perturbations and ultimately compromises the long-term viability of the supply chain. Therefore, supply chain resilience has become a critical focus as firms face frequent disruptions from natural disasters, geopolitical events, and pandemics. Resilience generally refers to a supply chain's ability to withstand, adapt to, and recover from disruptions, maintaining or quickly returning to desired performance levels. A fragile supply chain might yield high profits under ideal conditions, but those gains are unreliable and contingent on the absence of disruptions. In contrast, a resilient supply chain may deliver slightly lower profits, yet does so with greater consistency and stability over time. Therefore, supply chain resilience should be a key consideration when designing systems aimed at reducing emissions and waste, ensuring that environmental performance is maintained under disruption. In the context of supply chain design aimed at minimizing costs and emissions through strategies such as circularity, disruptions can manifest as technological or pathway failures, undermining efforts to meet circularity and emission reduction targets. For example, dependence on a limited set of technologies for end-of-life treatment of plastics can introduce vulnerabilities. If supply chains overly rely on a narrow selection of recycling or treatment technologies, they risk disruption if those technologies encounter shortages in essential raw materials, experience technical breakdowns, or face operational challenges due to specific environmental or economic conditions. Such disruptions can compromise the resilience and flexibility of supply chains, highlighting the importance of incorporating diverse technological pathways and maintaining adaptive capacities to ensure continuous alignment with circular economy objectives.

Designing a supply chain that integrates GHG emission reduction and circularity principles is fraught with uncertainty. Significant variability arises from multiple sources, including the quality and completeness of data used for economic assessments, environmental impact calculations, and material flow analysis. These uncertainties stem from sources such as life cycle inventory datasets, fluctuating market conditions, and limitations in forecasting technological performance and adoption rates. As a result, the outcomes of such analyses can vary widely depending on the input data probability distributions and modeling choices. Therefore, it is critical that uncertainty is not only acknowledged but rigorously quantified and integrated into the design process. Doing so enables more robust decision-making by highlighting the range of possible outcomes, identifying risk-prone strategies, and guiding investments toward solutions that remain viable under a wide array of future scenarios.

Finally, designing value chains that balance cost, emissions, and circularity involves complex trade-offs across competing objectives, making decision-making inherently difficult. Despite growing interest in sustainable and circular design, there remains a lack of robust, integrated, and user-friendly tools to support system-level decisions that span environmental and economic domains. Most existing methods are fragmented and fail to provide a holistic view or guide users through the interpretation of multi-objective results.

Incorporating the above-mentioned aspects into the supply chain design requires a paradigm shift from focusing exclusively on any one metric to adopting a multi-criteria design approach, one that simultaneously targets several goals of interest while ensuring cost-effective, resilient solutions and accounting for uncertainty. In addition, these efforts must be supported by integrated, user-friendly tools that effectively communicate design insights to stakeholders, who ultimately drive decisions that enable circularity and emission reduction.

Table 7 presents previous research that addressed some of these challenges in the pursuit of sustainable supply chains by employing life cycle optimization frameworks. Cost or profit considerations have been consistently included across all reviewed studies, underscoring the continued centrality of economic performance for businesses, even in the context of growing sustainability priorities. This widespread inclusion highlights the practical reality that economic viability remains a fundamental driver of decision-making, even when sustainability goals such as GHG emission reduction are pursued.

Many of these studies simultaneously considered cost and GHG emissions, reflecting an integrated approach to economic and environmental performance, particularly when GHG emission reduction was emphasized as a core sustainability goal. However, in several cases, GHG emissions were not directly treated as optimization objectives; instead, scenario-based approaches were employed to guide the sector toward reducing carbon emissions without embedding emissions reductions explicitly in the mathematical formulation.

Despite this increasing convergence between economic and environmental objectives, circularity remains largely underrepresented in such integrative frameworks. Only a handful of studies incorporated circularity, either through minimizing waste generation, minimizing resource consumption, or maximizing re-cycling rates and circularity metrics. Notably, only a few studies were identified as integrating all three dimensions (GHG emission, circularity, and cost) within a multi-objective optimization framework. This gap may be attributed to the inherent complexities involved in modeling closed-loop supply chains and circular flows, which often require more sophisticated life cycle modeling approaches than linear systems.

Moreover, supply chain resilience and uncertainty were predominantly explored using sensitivity analyses, scenario-based uncertainty assessments, or dynamic, multi-period, multi-stage stochastic optimization frameworks. These approaches captured temporal variability and risk but were not aligned with a comprehensive framework that simultaneously addresses GHG emissions, circularity, cost-effectiveness, and system resilience. Thus, there remains a significant methodological and practical gap in designing optimization frameworks that holistically capture all of these critical dimensions.

Finally, none of the previous studies offer a tool that integrates these design aspects into a user-friendly, accessible platform. While existing methods may be valuable for academic audiences and experts in multi-objective optimization, their complexity often prevents broader adoption and limits their impact on real-world decision-making. Without intuitive tools, the translation of advanced design insights into actionable strategies remains a major barrier.

TABLE 7
Literature review of life cycle optimization problems towards sustainability targets
with mixed objectives (cost, circularity, GHG emissions, and resilience).

| | | | | | | Decision |
|---|---|---|---|---|---|---|
| Case Study | GHG | Circularity | Cost | Resilience | Uncertainty | Support Tool |
| Net-zero global chemical supply | | | x | | p¹ | |
| chain [8] | | | | | | |
| Management of computer | | x | x | | | |
| waste [13] | | | | | | |
| Fresh food sustainable | x | | x | | | |
| distribution [14] | | | | | | |
| Converting waste plastics into | x | | x | | p² | |
| petrochemicals [15] | | | | | | |
| Sustainable lightweight aggregate | x | | x | | p² | |
| concrete [16] | | | | | | |
| Biogas supply chain [17] | x | | x | | x | |
| Integrated crop livestock system | x | | | | x | |
| for biofuels production [18] | | | | | | |
| Hydrocarbon biofuel supply | x | | x | | x | |
| chain [19] | | | | | | |
| Hydrocarbon biorefinery [20] | x | | x | | | |
| Microalgae biorefinery [21] | | | x | | | |
| Medical device supply chain [22] | x | | x | x | x | |
| Methanol from renewable | x | | x | | | |
| resources [23] | | | | | | |
| Waste-to-energy plant [24] | x | | x | | | |
| Integrated waste management [25] | x | | x | | | |
| Green supply chains [26] | x | | x | | | |
| Sustainable packaging supply | | | x | | | |
| chain [27] | | | | | | |
| Hydrogen supply chain [28] | x | | x | | x | |
| Automobile part manufacturing [29] | x | | x | | | |
| Algal biorefinery [30] | x | x | x | | | |
| Plastics waste management [31] | x | | x | | | |
| Paper industry [32] | x | x | x | | | x |
| Wine supply chain [33] | x | | x | | x | |
| Hydrocarbon biofuels [34] | x | | x | | | |
| Plastic & paper carrier bag value | x | x | x | | | |
| chains [35] | | | | | | |
| Polyethylene terephthalate (PET) | x | x | x | | | |
| supply chain [36] | | | | | | |
| Supply chain of multi-layer plastic | x | x | x | x | x | |
| films (present study) | | | | | | |

“p” denotes partial consideration, “x” denotes full consideration.
¹Scenario-based analysis; uncertainty handled as scenarios, not in the optimization model.
²Sensitivity analysis for uncertain inputs; not embedded in the optimization.

Researchers have increasingly sought quantitative ways to model and optimize resilience, moving beyond qualitative frameworks to incorporate resilience metrics directly into mathematical optimization models. Different studies have used specific resilience metrics for optimization such as cost or performance loss due to disruptions, recovery speed/area under the performance curve, network topology and redundancy metrics, to name a few. Cost-based metrics emphasize financial impact, while connectivity metrics emphasize structural robustness. To incorporate these metrics, researchers have employed a variety of approaches. Stochastic programming has been widely used to model supply chain disruptions as random events with certain probabilities or scenarios. In a typical two-stage stochastic model, strategic decisions are made in the first stage, and then a disruption scenario is realized, after which operational decisions are made in the second stage. The goal is often to minimize expected cost, including penalties for disruption impacts, or to optimize a combination of expected cost and resilience. Robust optimization offers an alternate paradigm, aiming for solutions that perform well for any realization of certain worst-case disruptions (within a defined uncertainty set). In supply chain resilience, robust models often seek to minimize worst-case cost or ensure feasible operations under worst-case disruption scenarios. This is typically done without assuming probabilities for disruptions, instead planning against an adversarial scenario or a set of disruptive events. Stochastic programming and robust optimization approaches often require data on the nature, frequency, and impact of disruptions, as well as how the supply chain performs under such perturbations. However, such dynamic and disruption-specific data are typically scarce during the early stages of resilient supply chain design, making it challenging to accurately parameterize these models. To reduce computational complexity and enhance the feasibility of implementation in large-scale systems, we formulate resilience using ecological resilience metrics derived from Ecological Network Analysis (ENA). These metrics, rooted in information theory, quantify the systemic capacity of a network to absorb disturbances while maintaining its functional integrity. Moreover, these static metrics align with dynamic engineering resilience metrics, as systems designed using ecological resilience metric have also demonstrated robustness from a dynamic standpoint. Therefore, by leveraging structural flow information and system organization, this approach provides a data-efficient and scalable means of capturing system-wide resilience without requiring detailed perturbation-response data typically needed in stochastic or robust optimization frameworks. The present disclosure goes beyond merely incorporating resilience into supply chain design for GHG emission reduction and circularity; the impact of incorporating resilience into the optimization framework was investigated and how it influences the optimization results and identified solutions.

Therefore, in the present disclosure, a static life cycle optimization framework is first proposed that holistically integrates GHG emission reduction, circularity, and cost through a systems-thinking approach, while ensuring supply chain resilience under uncertainty. Static analysis offers advantages such as being computationally efficient, requiring fewer data inputs by relying on network structure properties, and providing clearer interpretability. It simplifies decision-making by focusing on a fixed system snapshot. As an initial screening tool, static analysis helps benchmark performance and identify promising strategies before introducing the complexity of dynamic modeling, making it valuable for optimizing steady-state operations and informing early-stage decisions.

Secondly, addressing multi-objective, system-level design problems, such as those involving trade-offs between cost, emissions, and circularity, presents inherent complexities due to conflicting goals and the need for holistic evaluation and effective interpretation of the results. These challenges are further compounded by the difficulty of making decisions across multiple, often competing, criteria. Traditional methods struggle to support effective decision-making under such conditions. To tackle these challenges, the present disclosure introduces a software tool-hereinafter referred to as TranZero, (Tool for developing Resource efficient And Net-Zero Emission ROadmaps). TranZero is a design and decision-support tool that integrates LCA, TEA, and multi-objective optimization into a unified framework. While it features advanced data visualization capabilities to aid user interaction, its core contribution lies in enabling systematic, resilient, and sustainable redesign of products and processes for circular, and sustainable outcomes.

As a case study, narrowing down the focus to the U.S. supply chain, options are evaluated and optimized for improving the circularity, resilience, costs, and environmental impacts of the supply chain of multi-layer plastic barrier film. These films are commonly used in food packaging and other applications requiring moisture, gas, or light resistance, and are typically composed of multilayer structures combining polymers such as polyethylene (PE), polyethylene terephthalate (PET), ethylene vinyl alcohol (EVOH), and polyamide (PA). These barrier films are not easily recyclable and require novel processes for their end-of-life recovery, which is essential for achieving net-zero emissions and a resource-efficient supply chain. However, the economic and environmental performance of these processes are not always promising, in part because many have yet to benefit from economies of scale, and others rely on downcycling or energy recovery rather than true material recovery. In addition, there may be trade-offs across different environmental impacts, economic metrics, and circularity. In previous work, we conducted an LCA and TEA, highlighting the hotspots and impacts of each technological solution as well as their cost implications. We have expanded on our previous work by performing a multi-objective optimization to identify circular supply chains that achieve a balance of economic performance, resilience, and environmental impacts. In addition, by integrating a single-stage stochastic optimization method, we address uncertainty in the LCA/TEA inventory data. TranZero-Barrier Film Version are introduced to demonstrate the capabilities and features of our software. Therefore, novelties of the present work are listed in the following:
A life cycle optimization framework is proposed to integrate emission reduction, circularity and cost targets for supply chain design and incorporates resilience to enhance long-term supply chain sustain-ability under uncertainty.
Supply chain resilience is formulated statically through network structural properties, eliminating the need for dynamic data on perturbations and system responses, and is seamlessly embedded within the optimization framework.
Life cycle optimizations of the supply chain for barrier films are performed to identify the most effective and resilient technological solutions based on environmental, economic, and circularity performance of this group of product.
A user-friendly tool (TranZero) has been developed to aid decision making process and effectively visualize the optimization outcomes. While currently tailored for multilayer plastic films, the tool can be adapted for other products as well.

In Section 2, we present the life cycle optimization framework, introduce the case study, and describe the TranZero tool. In Section 3, we present the life cycle optimization results for the barrier films supply chain and discuss the impact of resilience on the optimization outcomes. We also demonstrate the software and its capabilities through this case study. In Section 4 we conclude by warping up this work and present future research direction.

### 2. METHODS

### 2.1 Computational Structure

To develop an integrated life cycle optimization framework, a computational structure is needed so that the objectives and constraints are formulated in a coherent and unified manner. Given that the optimization seeks to determine the optimal technological pathways, the decision variables must capture the degree of adoption or selection of each technology across different stages of the life cycle. We build upon the mathematical structure of LCA as the foundation for modeling the life cycle optimization system.

In the following, we first provide a brief introduction to the mathematical structure of LCA. We then demonstrate how LCA is applied to model a cradle-to-grave systems using an illustrative example. Building on this, we propose a generalized mathematical formulation for our framework, enabling the modeling of cradle-to-grave systems in a generic manner.

In LCA, the technology matrix (A) represents the relationships between products, processes, and technological flows within a system through per-unit coefficients. In mathematical terms, it is a matrix that connects the per-unit inputs and outputs of multiple processes, providing a framework to describe the life cycle network. Each element of the matrix A (denoted as aᵢⱼ) represents a technological flow i associated with process j (A technological flow refers to the exchange of materials, products, or energy between processes), where a positive value indicates an output and a negative value indicates an input. Each process is linked to a designated reference flow (i.e., aᵢᵢ), which serves as the basis for scaling the process up or down. Similarly, per-unit environmental flows from each process are captured in the intervention matrix (B) corresponding to the unit of the reference flow of each process, where each element of the matrix B (bₖⱼ) represents the environmental flow of type k emitted or consumed per unit of the reference flow from process j. After defining the per-unit matrices, the system is scaled using the final demand vector f, with fᵢ specifying the required amount of each flow in the economy or society. This vector represents the external demand for products or services, guiding the scaling of processes in the system to meet these demands. The technology matrix A links the process scaling vector s (where sⱼ denotes the scale of process j), the primary decision variable, to the final demand or functional unit vector f, using the following equation:

$$As = f \qquad ( 1 )$$

Using this equation, the scale of each process can be calculated. From these scaling factors, the total environmental flows vector g (where gk represents the total environmental flows of type k entering or leaving the system) can be calculated by scaling the per-unit B matrix using the following equation:

$$g = Bs \qquad ( 2 )$$

The scaling factors for each process can be used to determine the material and energy flows throughout the system, which are essential for evaluating cost and circularity metrics. GHG emissions can be represented as environmental flows associated with each process, and the total GHG emissions for the system can be computed accordingly.

### 1.1.1 Illustrative Example for a Cradle-to-Grave System Boundary

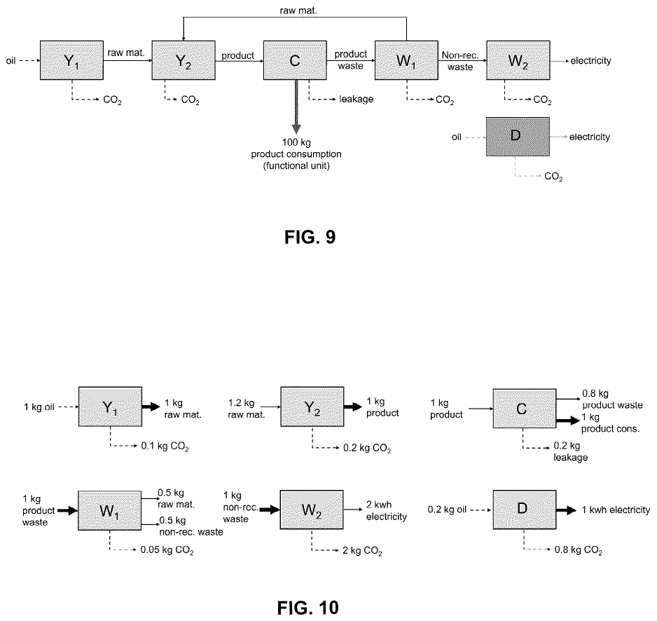

An illustrative example is presented below to demonstrate the LCA mathematical framework for a cradle-to-grave system boundary (FIG. 9). In this case, the functional unit represents the sole output leaving the system boundary, with no other flows exiting the system. This is typical in cradle-to-grave LCA modeling. The functional unit may take the form of a physical product, a specified number of units, or a non-physical output such as a service delivered to society. For cradle-to-grave LCA modeling, regardless of whether the functional unit is physical or non-physical, it does not correspond to an actual output flow leaving the system. Rather, it serves as a dummy flow introduced to enable the mathematical scaling of both upstream and downstream end-of-life stages with respect to the final demand.

In this example, the functional unit is defined as 100 kg of product consumed, or equivalently, the service provided to society by 100 kg of product. The upstream system includes processes Y₁ and Y₂, representing raw material production and product manufacturing, respectively, to supply the product to the consumer. In the end-of-life phase, the process W₁ receives the post-consumer product waste that is collected (i.e., not leaked to the environment), treats it, and recovers raw materials as a byproduct. This treatment process also generates non-recyclable residual waste (non-rec. waste), which is subsequently directed to an energy recovery unit (W₂) that produces electricity as a byproduct.

Since the electricity generated is not utilized within the circular network, it is treated as a byproduct sent to a secondary system, representing an open-loop recovery strategy. The environmental credit associated with this electricity can be calculated using the displacement (or substitution) approach. This method assumes that the recovered electricity displaces an equivalent amount of electricity that would have otherwise been produced elsewhere in the economy. Consequently, the emissions from the displaced process can be credited to the system. The substituted process, denoted as D and shown in red in FIG. 9 lies outside the boundaries of the circular network but is incorporated into the overall system model to account for the credited emissions.

FIG. 9 depicts the system boundary for the illustrative example. Solid arrows denote technological flows, while dashed arrows represent environmental flows. The thick blue solid arrow indicates the cradle-to-grave functional unit of the system. The red rectangle highlights the process that is displaced elsewhere in the economy due to the generation of a byproduct within the system. (Y₁: raw material production, Y₂: product manufacturing, C: consumer, W₁: waste recovery process, W₂: energy recovery process, D: displaced electricity production from oil.)

The technology matrix (A) and the environmental intervention matrix (B) are constructed based on the per-unit flows illustrated in FIG. 10. FIG. 10 depicts processes with normalized flows used to construct the A and B matrices in the illustrative example. Solid arrows represent economic flows, while dashed arrows represent environmental flows. Thick solid arrows indicate the reference flow for each process (Y₁: raw material production, Y₂: product manufacturing, C: consumer, W₁: waste recovery process, W₂: energy recovery process, D: displaced electricity production from oil.)

| | — | Y₁ | Y₂ | W₁ | W₂ | D | C |
|---|---|---|---|---|---|---|---|
| A= | raw mat. | 1 | −1.2 | 0.5 | 0 | 0 | 0 |
| | product | 0 | 1 | 0 | 0 | 0 | −1 |
| | product waste | 0 | 0 | −1 | 0 | 0 | 0.8 |
| | non - recoverable waste | 0 | 0 | 0.5 | −1 | 0 | 0 |
| | electricity | 0 | 0 | 0 | 2 | 1 | 0 |
| | consumption | 0 | 0 | 0 | 0 | 0 | 1 |
| B= | oil | −1 | 0 | 0 | 0 | −0.2 | 0 |
| | CO₂ | 0.1 | 0.2 | 0.05 | 2 | 0.8 | 0 |
| | leakage | 0 | 0 | 0 | 0 | 0 | 0.2 |

As further shown in FIGS. 10, Y₁ and Y₂ are production processes, characterized by output reference flows. In contrast, W₁ and W₂ are waste processes with input reference flows. This configuration enables consistent scaling of both upstream (pre-consumer processes) and downstream (post-consumer processes) stages by linking production and waste processes through a consumer node. Although the consumer node does not generate any tangible output, it is modeled as a production process because its reference flow, representing product consumption, is defined as an output.

The final demand is defined as the consumption of 100 kg of product, which serves as the functional unit for this example. Accordingly, the final demand vector is given as:

$$f = \begin{matrix}0 \\ 0 \\ 0 \\ 0 \\ 0 \\ 100\end{matrix}$$

A scaling vector defining the scaling factors can thus be determined using Equation 1. Subsequently, the total environmental flows from the system, represented by the vector g, can be calculated using Equation 2.

$$s = \begin{matrix}80 \\ 100 \\ 80 \\ 40 \\ - 80 \\ 100\end{matrix}$$

$$g = \begin{matrix}- 64 \\ 48 \\ 20\end{matrix}$$

This functional unit results in 48 kg of CO₂ emissions from the system, 20 kg of material leakage to the environment, and 64 kg of oil consumption, represented as a negative value. The negative scaling factor for the electricity generation process does not imply that negative flows are being produced; rather, it indicates that the process and its associated flows are being displaced elsewhere in the economy. This displacement yields credits of 64 kg CO₂ and 16 kg of oil, effectively reducing the system's total emissions and resource use. Without these credits, i.e., in the absence of displaced electricity, the overall CO₂ emissions and oil consumption would have been 84 kg and 80 kg, respectively.

### 2.1.2 General LCA Mathematical Framework for Cradle-to-Grave Systems

The illustrative example in Section 2.1.1 demonstrates the construction of LCA matrices, the calculation of process scaling factors, and the estimation of the system's environmental flows. In this section, we introduce a generalized framework for constructing LCA matrices for a cradle-to-grave system. We then build upon this framework to develop our optimization model, where objective functions and constraints are formulated based on the mathematical structure of LCA.

The technology matrix (A) and the environmental intervention matrix (B) can be constructed in the same manner as demonstrated in the illustrative example. These matrices are composed of production processes (A_{y}, B_{y}), waste processes (A_{w}, B_{w}), substitution processes representing displaced activities elsewhere in the economy (A_{d}, B_{d}), and consumer nodes (A_{c}, B_{c}). Notably, the model is not limited to a single consumer node; instead, a distinct consumer node can be assigned to each product. This structure enables more accurate attribution and tracking of emissions associated with the consumption of individual products within the network.

$$A = [ \begin{matrix}{A}_{y} & {A}_{w} & {A}_{d} & {A}_{c}\end{matrix} ] \qquad ( 3 )$$

$$B = [ \begin{matrix}{B}_{y} & {B}_{w} & {B}_{d} & {B}_{c}\end{matrix} ] \qquad ( 4 )$$

Similarly, the final demand vector does not have to be limited to a single functional unit; rather, it can represent multiple functions, each corresponding to the consumption of a specific product. These functional units are captured in the vector fc, with all other entries in the f vector set to zero, as no final demand is associated with the remaining processes:

$$f = \begin{matrix}0 \\ fc\end{matrix} \qquad ( 5 )$$

This framework was used to model the life cycle network for the optimization problem.

### 2.2 Indicators

### 2.2.1 Environmental Indicator

To calculate the total environmental impacts of a system (φ), such as GHG emissions impacts (or global warming potential (GWP)), we multiply the environmental flow vector g to the characterization factor matrix C. This matrix contains the characterization factors derived from a chosen impact assessment method. These factors quantify the potential environmental impacts of individual environmental flows by relating them to a common unit within specific impact categories, such as GHG emission impact. The total environmental impact φ is computed as follows:

$$Φ = {C}^{T} g \qquad ( 6 )$$

Therefore, our first objective function, i.e., GHG emission impact, is represented as a specific element of the total environmental impact vector, denoted as φ_{GHG} representing the GHG emissions associated with the system. Therefore, the environmental objective function can be calculated as:

$${ψ}_{1} ( s ) = {ϕ}_{G H G} ( s ) = {C}_{G H G}^{T} B s \qquad ( 7 )$$

where C_{GHG}^{T} represents the vector of characterization factors for global warming potential, which are used to convert individual environmental flows, such as CO₂, CH₄ and other GHG emissions, into their equivalent GHG emission impact over 100 years based on established impact assessment methodologies.

This objective function is explicitly a function of s, which represents the vector of scaling factors or decision variables. Each element in s corresponds to the degree or scale to which a particular process is selected and implemented across the life cycle. Unlike a binary or logistical approach, where processes are treated in a discrete manner, being either fully selected or excluded, this formulation considers the selection of processes as a continuous decision. This continuous representation allows the scale of each process to vary within a feasible range, enabling the optimization framework to identify optimal emission reduction pathways that strike a balance between multiple objectives.

### 2.2.2 Circularity Indicator

Circularity indicators have been developed to measure waste generation and its recovery within the system. Furthermore, as circular economy strategies gain prominence, it becomes increasingly important to measure progress toward circularity. In the present disclosure, a modified material circularity indicator, adapted from the Ellen Macarthur Foundation's circularity indicator is proposed by refining the allocation method used to distribute waste between primary and secondary processes. This metric employs an economic allocation approach to account for both quality degradation and economic value loss in open-loop recycled materials (the recovered byproduct exiting the system and directing to a secondary production system). This method ensures distinguishing between different open-loop recovery strategies, favoring those that produce higher-value (or higher quality) products. It encourages the primary production system to make byproducts of higher quality that can stay within the economy longer or can be recycled multiple times. The original definition of EMF's material circularity indicator (MCI) is presented in the following:

$$MCI = 1 - \frac{V + M}{2 M} \qquad ( 8 )$$

where V is the mass of virgin material used directly to make the product, W is the waste generated, and M is the mass of the product.

To calculate W in open-loop recycling, EMF has suggested different allocation approaches, such as the cut-off approach, where the primary production system is not responsible for the waste generated by secondary production, or the 50:50 approach, where the primary and secondary production systems equally share responsibility for the waste generated in both systems. In the 50:50 approach, W is calculated as:

$$W = \frac{{W}_{p r i m a r y} + {W}_{secondary}}{2} \qquad ( 9 )$$

where W_{primary} represents the waste generated by the primary production system and W_{secondary} represents that of the secondary system. The calculation of W_{secondary} requires detailed information about the fate of materials after they leave the primary system. However, such information is often unavailable or difficult to obtain. Moreover, the 50:50 allocation approach penalizes both the primary and secondary systems equally, regardless of the quality of the materials transferred from primary to the secondary system. This can discourage the production of higher-quality outputs from the primary system. For example, if the recovered material from an open-loop system is a low-grade polymer resin, it may be less suitable for further recycling or may require mixing with significant amounts of virgin material to restore its properties. In contrast, a high-quality recovered polymer may perform better in secondary applications and remain recyclable at the end of its subsequent life. Therefore, a primary production system that yields high-quality recyclable byproducts should be recognized with a higher degree of circularity, as it contributes more effectively to material retention within the economy. Therefore, the following formulation for total waste calculation for the primary system is proposed:

$$W = {W}_{p r i m a r y} + ( 1 - γ ) {M}_{s e c o n d a r y} \qquad ( 10 )$$

where γ is defined as the ratio of the price of the secondary product (or recovered material) to the price of the primary material (called the recovery price ratio), it serves as a proxy for quality retention in the circular economy, and M_{secondary} is the amount of recovered material or product. A higher value of γ indicates that the recovered material retains a greater portion of its original economic value, suggesting minimal quality degradation through the recycling process. Conversely, a lower value of γ reflects significant loss in economic value, implying that the material has undergone functional or compositional downgrading. This quality-adjusted perspective is incorporated into the modified calculation of W, which is then used in the formulation given by Eq 8, serving as the second objective in the multi-objective optimization problem.

In scenarios where the end-of-life output is recovered in the form of energy, such as electricity or thermal energy, the secondary material flow, denoted as M_{secondary}, corresponds to the mass of material directed to energy recovery processes. Unlike material recovery pathways where the displaced product is a material commodity, in this case, the system substitutes for an energy carrier. To account for the value of energy recovery in the circularity metric, the quality-adjusted economic factor (γ) captures the economic equivalence between the recovered energy and the primary product and is used to scale Mₛ accordingly. Specifically, in this case γ is defined as the price of energy (electricity or heat) that can be generated per kilogram of waste input, divided by the unit price of the main (primary) product.

$${v}_{e} = \frac{{P}_{secondary} * {E}_{secondary}}{{P}_{p r i m a r y}} \qquad ( 11 )$$

where:
γₑ represents quality factor for the energy recovery scenarios,
P_{secondary} is the market price of electricity or heat (e.g., $/kWh or $/MJ),
E_{secondary} is the amount of energy that can be recovered per unit mass of waste (e.g., kWh/kg or MJ/kg),
P_{primary} is the market price per unit of the primary product (e.g., $/kg).

This approach allows energy recovery processes to be incorporated into the circularity indicator in a manner consistent with economic allocation principles. The values of γ are computed and presented in the Supplementary Information.

Since we are employing a life cycle-based mathematical framework, the circularity metric must be formulated in alignment with this approach. Material circularity in the system depends on the magnitudes of the virgin input (V), waste output (W), and manufactured product (M), all of which are derived from the process flows encoded in the technology matrix (A) and their corresponding scaling factors. V represents the input of virgin material, which is calculated by multiplying the scaling factor of the manufacturing processes (s_{y}) by the per-unit input of virgin raw material from those processes (|a_{vy}|). Similarly, W captures the waste generated by consumer use and end-of-life processes that either exit the system or are sent to landfill. This is computed by multiplying the scaling factors of these processes (Sc and Se) with their respective waste flows in A (a_{wc} and a_{we}). The quantity M reflects the total product manufactured, determined by the manufacturing process scaling factor (s_{y}) multiplied by the corresponding product flow in A (a_{my}). Since waste allocation is performed using a quality-based approach, the flow of recovered material that substitutes for virgin products elsewhere in the economy is denoted as M_{secondary}. This is calculated by multiplying the scaling factor of the displaced process (|s_{d}|) by its unit flow in A (a_{dd}). Based on these definitions, the formulation of the circularity indicator, used as the second objective function in our optimization problem, is presented below:

$${ψ}_{2} ( s ) = 1 - \frac{\begin{matrix}{\sum }_{y} {\sum }_{v} \vert {a}_{v y} \vert {s}_{y} + {\sum }_{c} {\sum }_{w} {a}_{w c} {s}_{c} + \\ {\sum }_{e} {\sum }_{w} {a}_{w e} {s}_{e} + ( 1 - γ ) {\sum }_{d} {a}_{dd} \vert {s}_{d} \vert\end{matrix}}{( 2 {\sum }_{y} {\sum }_{m} {a}_{m y} {s}_{y} )} \qquad ( 12 )$$

### 2.2.3 Economic Indicator

To support informed decision-making for emission reduction and circular economy implementation, it is critical to perform a techno-economic analysis (TEA) and incorporate economic indicators into the evaluation of circularity strategies. In this study, we adopt the total supply chain cost (TSC) as the principal economic performance metric. This indicator provides a quantifiable basis for assessing the financial implications of different circularity pathways, complementing environmental objectives. The detailed methodology for cost estimation and the assumptions underlying the calculation of TSC are presented in our previous work. Within the optimization framework, TSC is modeled as the summation of the product of process-specific scaling factors multiplied by their corresponding normalized production costs, which results in the following third objective:

$${ψ}_{3} ( s ) = T S C = {\sum }_{j = 1}^{{n}^{*}} T P {C}_{j} \times {s}_{j} \qquad ( 13 )$$

where j is the index of the node in the system, n* is the number of processes in the network that are included in the cost calculation, and TPC is the total production cost for each process (per unit of reference flow). While a full cradle-to-grave cost model is possible (n being the total number of nodes in the system), we deliberately narrow the scope to focus on downstream manufacturing and end-of-life processes (n*). This choice reflects the fact that these stages are the most relevant and sensitive to the choice of circularity strategy. For example, if a closed-loop strategy is employed in which post-consumer waste is recycled into polymer resins and reintegrated into the manufacturing process, the resulting change in feedstock, virgin versus recycled resin, can significantly alter the production cost of the film. Recycled resins typically differ in price due to quality variation, availability, and processing requirements.

By isolating cost variations in the downstream and end-of-life phases, TSC captures the economic impacts most relevant to decision-makers who are directly responsible for implementing circular strategies. This is particularly important in policy contexts involving Extended Producer Responsibility (EPR), where manufacturers are held accountable for the end-of-life management of their products. In such cases, TSC serves as a single-stakeholder economic performance metric, guiding firms toward more cost-effective circular strategies. Conversely, in systems where end-of-life processing is managed by entities independent of downstream manufacturers, TSC can be disaggregated into stakeholder-specific components. This enables hotspot cost analysis, identifying how the benefits or burdens of circular strategies are distributed. Such analysis is crucial when interests are not aligned, i.e., when a circularity strategy that reduces costs for one stakeholder (e.g., the recycler) imposes higher costs on another (e.g., the manufacturer), potentially leading to coordination failures or misaligned incentives in supply chain design and policy implementation.

It is important to note that this disclosure does not account for economies of scale. All technologies are modeled under the assumption that they operate at mature, steady-state conditions with fully developed infrastructure and supply chains. This approach is particularly useful for early-stage design and comparative assessments, where the goal is to evaluate the intrinsic performance of technologies rather than their deployment scale. It enables more transparent benchmarking and supports decision-making under the assumption of technological parity, independent of current market dominance or production volumes. Additional information about the TEA can be found in our related publication.

### 2.2.4 Resilience Indicator

A resilience indicator is introduced and incorporated in the life cycle optimization to ensure that supply chain solutions are resilient over the long run and at the time of perturbation. We use a network-based static resilience indicator, based on the structural properties of nodes and flows within a network, derived from ENA. This concept, originally applied to ecological systems such as food webs, has proven effective in assessing the resilience of interconnected systems.

Instead of treating resilience as an objective function, we incorporate it as a fundamental constraint within the optimization framework. This approach is inspired by the ecological concept of the “Window of Vitality,” which characterizes the conditions under which food webs maintain stability and adaptability. Specifically, this concept ensures that the Degree of System Order (DoSO), a network property that quantifies the structure of nodes and flows, remains within a specific range (i.e., from 0.213 to 0.589) that has been empirically associated with resilience in natural systems. By drawing from ecological principles, we impose this constraint on the optimization formulation, requiring that the network's structural order for a given decarbonization strategy falls within this predefined range. This ensures that the system is not only optimized for efficiency in achieving its targets but also retains the necessary structural diversity to withstand and recover from various perturbations.

The metric used for the resilience constraint, i.e., DoSO, can be quantified using input-output flow data extracted from the network. To compute DoSO, it is necessary to transform the technology matrix (A) in the LCA framework into an equivalent input-output matrix (R). This transformation ensures the data structure aligns with the requirements for analyzing flow networks. Additionally, calculation of DoSO necessitates that all flows within the network be expressed in a consistent unit of measurement. A methodology and corresponding equation is proposed to convert the technology matrix (A) into the input-output matrix (R). The first step involves setting the diagonal elements of the A matrix, or the reference flows to zero (in the case that A is a rectangular matrix. Otherwise, the reference flows may not necessarily be the diagonal elements, which in this case should be set to zero manually), as these elements do not directly contribute to the representation of an input-output flow network. The A matrix entries reflect inputs normalized to a specific reference flow; thus, the next step is to multiply these values by a scaling factor associated with their respective nodes. This operation ensures that the normalized inputs are appropriately scaled to represent the actual flow values. Furthermore, given that resilience analysis requires uniform units across all flows, it is imperative to harmonize the units by applying a conversion factor to the matrix elements. The final transformed matrix, denoted as T (with elements tᵢⱼ), can be computed using the proposed equation, which encapsulates these sequential operations.

$${t}_{i j} = {a}_{i j} {q}_{i j} {s}_{j} {u}_{i} \qquad ( 14 )$$

where qᵢⱼ is 0 for i=j and 1 for il=j, and uᵢ is the unit conversion factor for flow i.

To derive the input-output matrix (R) from the transformed matrix (T), it is necessary to adjust the sign of the values and reorganize the matrix structure. All negative values in T must be converted to their absolute positive equivalents, as they represent input flows in the technology matrix, while the initial positive values in T, which signify output flows in A matrix, must be transposed to occupy the corresponding positions in R. In mathematical terms, the elements of R (rᵢⱼ) are computed using the following equation:

$${r}_{ij} = \{ \begin{matrix}\vert {t}_{ij} \vert & if {t}_{ij} < 0 , \\ {t}_{ij} & if {t}_{ij} > 0 , \\ 0 & if {t}_{ij} = 0\end{matrix} .$$

DoSO can be calculated using the following equation, derived from ENA:

$$D o S O = \frac{{\sum }_{I , j} {r}_{i j} log \frac{{r}_{ij}}{{r}_{..}}}{( {\sum }_{i , j} {r}_{i j} * log ( \frac{{r}_{i j} {r}_{..}}{{r}_{. i} {r}_{. j}} ) )} \qquad ( 16 )$$

Since the elements of R are influenced by the scaling factors s (as outlined in Equation 14), the resilience metric in equation 16 is inherently a function of scaling factors. A constraint is imposed based on the range of the system's degree of order required for the network to remain within the window of vitality, a conceptual range in which the network retains its functionality and adaptability. Imposing this constraint ensures that the system operates within the window of vitality, thereby supporting long-term resilience. This approach integrates supply chain resilience as a critical parameter in life cycle optimization.

To define a more targeted resilience metric, we restrict our scope to include only those flows within the system boundary that pertain directly to raw material inputs, the final product (i.e., the multilayer plastic film), and the associated product waste. By focusing exclusively on these core components, we emphasize the technological resilience of the system, specifically its ability to maintain the production, provision, and end-of-life treatment of the product under potential disruptions. This narrowed scope allows for a more meaningful assessment of resilience in the context of product-level circular economy.

### 2.3 Multi-Objective Static Life Cycle Optimization Formulation

In this section, a technology-agnostic static multi-objective life cycle optimization formulation has been designed to identify supply chain solutions that are economically viable, environmentally sustainable, and resilient under uncertainty. We employ the epsilon constraint method, a multi-objective optimization approach that designates one objective function as the primary objective to be optimized while reformulating the remaining objectives as constraints. This is achieved by introducing threshold values, denoted as E, which serve as upper or lower bounds for these secondary objectives. To determine appropriate e values, we first solve a series of single-objective optimization problems, each corresponding to an individual objective function. The resulting optimal values define the feasible range for E, establishing the bounds for the constrained objectives. Once these bounds are determined, we systematically vary the e values within their respective ranges and optimize the primary objective under each E value. This process yields a set of solutions that illustrate the trade-offs between competing objectives, ultimately constructing the Pareto front, a frontier of non-dominated solutions where no objective can be improved without compromising another. To enhance solution quality and ensure dominance, we adopt the augmented epsilon constraint method, which introduces a penalty variable along with slack parameters in the formulation of both the primary objective and epsilon constraints. These modifications mitigate the risk of generating weak, non-dominant solutions and improve the robustness of the optimization process while maintaining computational efficiency [51].

To address optimization under uncertainty, a scenario-based single-stage stochastic optimization approach is employed to account for variability in life cycle and techno-economic data across different technological alternatives. The single-stage stochastic framework is appropriate because the system is modeled in a static manner, where all decisions are made “here and now” prior to the realization of uncertain parameters. This approach ensures that decisions are robust by explicitly incorporating uncertainty into the optimization process. To represent the uncertainty, a Monte Carlo simulation is performed with 10,000 iterations, generating a comprehensive set of scenarios. Each scenario corresponds to a specific realization of uncertain parameters, represented as the uncertainty parameter vector (ξ), which governs the behavior of the objective functions and constraints.

The optimization process aims to minimize the objective function values for a given uncertainty scenario. This is mathematically formulated within the optimization framework, as shown in Equation 17-21, where the objective functions and constraints are expressed as functions of the uncertainty parameter for scenario l, denoted as ξ^{l}. Here, l represents one of the 10,000 scenarios generated through Monte Carlo simulation.

Accordingly, the general formulation for the multi-objective optimization problem is presented as follows:

$${min}_{x ∈ X} {ψ}_{1} ( x , {ξ}^{l} ) - ρ {\sum }_{h = 2}^{H} {L}_{h} \qquad ( 17 )$$

$$s . t . {ψ}_{h} ( x , {ξ}^{l} ) + {L}_{h} = {ϵ}_{h} , h = 2 , … , H \qquad ( 18 )$$

$${α}_{p} ( x , {ξ}^{l} ) = 0 , h = 2 , … , H \qquad ( 19 )$$

$${β}_{θ} ( x , {ξ}^{l} ) \leq 0 , p = 1 , … , P \qquad ( 20 )$$

$$x ∈ X \qquad ( 21 )$$

In this formulation, x represents the optimization variable (decision factor), and X denotes the decision space. The primary objective function is given by ψ₁ (Equation 17), while ψₕ represents the remaining objectives formulated as epsilon constraints (Equation 18), with H as the total number of objectives. A small penalty variable, ρ, ranging between 10⁻³ and 10⁻⁶ (depending on the nature of the objective function), is introduced alongside slack variables Lₕ to implement the augmented epsilon constraint method. The epsilon constraint value is denoted by ϵₙ, and αₚ (Equation 19) and β_{θ} (Equation 20) represent the equality and inequality constraints, respectively.

The optimization is conducted over 10,000 scenarios generated through Monte Carlo simulation, each of which produces a distinct solution x^{l} along with corresponding objective function values ψ₁ (x^{l}, ξ^{l}) and ψₕ (x^{l}, ξ^{l}). Since each scenario represents a unique realization of uncertain parameters ξ^{l}, the optimization results in a set of scenario-specific Pareto fronts, capturing the trade-offs among competing objectives under varying conditions. This approach enables a comprehensive exploration of solution robustness, ensuring that the final decision-making process accounts for a wide range of possible uncertainties.

To facilitate a more insightful analysis of the Pareto fronts, we can focus on specific representative solutions that capture different extremes and typical cases within the solution space. This involves identifying solutions corresponding to the best case, worst case, and median case scenarios, allowing for a deeper understanding of trade-offs under varying conditions.

Best Case Scenario (x_{best case}): This scenario represents the most favorable outcome among the optimized solutions, where the primary objective function is the minimum value among the optimized solutions for all scenarios (ψ₁(xₗ, ξ^{l}) for l from 1 to 10,000).

$${x}_{best case} ∈ arg min \{ {ψ}_{1} ( {x}^{1} , {ξ}^{1} ) , {ψ}_{1} ( {x}^{2} {ξ}^{2} ) , … , {ψ}_{1} ( {x}^{10 , 000} , {ξ}^{10 , 000} ) \}$$

This solution provides insight into the most efficient or ideal system performance achievable under the given constraints.

Worst Case Scenario (x_{worst case}): This scenario captures the most unfavorable conditions, where the primary objective function is the maximum value among the optimized solutions for all generated scenarios (ψ₁(x^{l}, ξ^{l}) for l from 1 to 10,000).

$${x}_{w orst case} ∈ arg max \{ {ψ}_{1} ( {x}^{1} , {ξ}^{1} ) , {ψ}_{1} ( {x}^{2} {ξ}^{2} ) , … , {ψ}_{1} ( {x}^{10 , 000} , {ξ}^{10 , 000} ) \}$$

This solution helps assess the system's vulnerability and the extent of performance deterioration under adverse conditions.

Median Case Scenario (x_{median case}): This scenario represents a more probable or typical outcome by selecting the solution closest to the median optimized objective function value.

$${x}_{m e dian case} ∈ arg {median}_{u p p e r} \{ {ψ}_{1} ( {x}^{1} , {ξ}^{1} ) , {ψ}_{1} ( {x}^{2} {ξ}^{2} ) , … , {ψ}_{1} ( {x}^{10 , 000} , {ξ}^{10 , 000} ) \}$$

where the median is taken from the upper half of the distribution to ensure a conservative yet representative estimate of likely system performance.

Next, a more detailed formulation of the multi-objective life cycle optimization framework is presented. It integrates key indicators of interest into the optimization model's objectives and constraints. This formulation provides a structured methodology for addressing trade-offs among environmental, economic, and circularity goals. The detailed optimization formulation is provided in the following:

$${min}_{s} {C}_{G H G}^{T} ( {ξ}^{l} ) B ( {ξ}^{l} ) s - ρ ( {L}_{2} + {L}_{3} ) \qquad ( 22 )$$

$$s . t . - ( 1 - \frac{\begin{matrix}{\sum }_{y} {\sum }_{v} \vert {a}_{v y} ( {ξ}^{l} ) \vert {s}_{y} + {\sum }_{c} {\sum }_{w} {a}_{w c} ( {ξ}^{l} ) {s}_{c} + \\ {\sum }_{w} {\sum }_{e} {a}_{e w} ( {ξ}^{l} ) {s}_{w} + ( 1 - γ ) {\sum }_{d} {a}_{dd} ( {ξ}^{l} ) \vert {s}_{d} \vert\end{matrix}}{2 {\sum }_{y} {\sum }_{m} {a}_{m y} ( {ξ}^{l} ) {s}_{y}} ) + {L}_{2} = {ϵ}_{2} \qquad ( 23 )$$

$${\sum }_{j = 1}^{{n}^{*}} T P {C}_{j} ( {ξ}^{l} ) {s}_{j} + {L}_{3} = {ϵ}_{3} \qquad ( 24 )$$

$$0.213 \leq \frac{( {\sum }_{i , j} {r}_{ij} ( s , {ξ}^{l} ) log ( \frac{{r}_{ij} ( s , {ξ}^{l} ) )}{{r}_{..} ( s , {ξ}^{l} )} ) )}{{\sum }_{i , j} {r}_{ij} ( s , {ξ}^{l} ) log ( \frac{( {r}_{ij} ( s , {ξ}^{l} ) {r}_{..} ( s , {ξ}^{l} ) )}{{r}_{.} ( s , {ξ}^{l} ) {r}_{, j} ( s , {ξ}^{l} )} )} \qquad ( 25 )$$

$$A ( {ξ}^{l} ) s = f ( {ξ}^{l} ) \qquad ( 26 )$$

$${s}_{j} \geq 0 ∀ j ∉ K \qquad ( 27 )$$

$${s}_{j} \leq 0 ∀ j ∈ K \qquad ( 28 )$$

where s represents the set of decision variables that define the selection of alternatives across each stage of the system's life cycle. These alternatives can inherently be multi-level, encompassing a wide range of options such as facilities, technologies, processes, equipment, and other operational or infrastructural components.

In this work, we focus on decision variables associated with selecting alternative technological solutions across the life cycle of a product to identify the optimal pathway. Equation 22 defines the environmental objective function. The circularity objective is incorporated as an epsilon constraint in Equation 23, and the cost objective is similarly formulated as an epsilon constraint in Equation 24. Equation 25 introduces the window of vitality constraint to capture and constrain system resilience, and Equation 26 ensures mass and energy balance across the system.

The scaling factors(s) have previously been constrained to be greater than or equal to zero in prior studies to ensure feasible and bounded solutions [37]. This assumption is appropriate for many conventional systems but may not hold when designing systems with circularity in mind. In particular, in the case of open-loop circular systems, where the end-of-life byproducts leave the system boundary and lead to displacement of processes elsewhere in the economy, the constraints on scaling factors may need to be relaxed when employing the LCA framework. When modeling such systems, the allocation of products from the end-of-life process can sometimes result in negative scaling factors. For example, when using a substitution approach in LCA, the aggregated processes or supply chain associated with a specific process are considered to be substituted in the broader economy. This substitution results in a negative scaling factor. Importantly, a negative scaling factor does not imply that a process has negative physical flows. Instead, it reflects the substitution effect from a macroeconomic perspective, where the modeled process displaces equivalent processes or flows in the economy. To accommodate this nuance, the optimization framework must address such cases explicitly. Processes or technologies that are substituted in the economy should be allowed to have a scaling factor that is zero or negative (equation 27). These processes lie outside the primary product's system boundary, with k representing the set of all process indices that are not directly involved in the main supply chain (displaced markets and processes). Conversely, all processes and technologies within the main supply chain must retain a scaling factor constrained to zero or positive values (equation 28).

The matrices A, B, f, and C are all subject to uncertainty, and therefore are all a function of ξ (the uncertainty vector). Uncertainty in A and B stems from variability in life cycle inventory (LCI) data quality for each process. For f, uncertainty arises from fluctuations in demand. In the case of C, uncertainty is introduced through the variability in characterization factors used to convert emissions into impact metrics. It is important to acknowledge that the total supply chain cost (TPCⱼ), while serving as a central economic indicator, is subject to uncertainty (ξ). This uncertainty arises from several key sources. First, there is variability in process technologies across different facilities, as operational efficiency, energy intensity, and material throughput can differ widely depending on the specific configuration and age of equipment. Second, the quality and characteristics of input feedstock—particularly recycled or waste-derived materials—can vary significantly by source, affecting both process performance and associated costs. Third, for emerging circularity strategies that rely on bench- or pilot-scale technologies, there is inherent uncertainty in how these systems will behave and perform when scaled to industrial levels. Cost structures, yields, and energy requirements may shift dramatically during scale-up, introducing further variability into the economic evaluation.

The resulting optimization problem is a Non-Linear Programming (NLP) model, which features non-linear relationships due to the inclusion of the resilience constraint. Ipopt solver is used to solve the optimization problem in this case study.

### 2.4 Case Study: Barrier Films

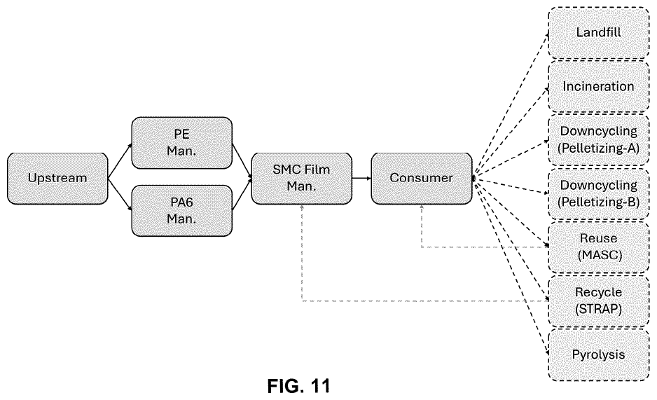

As a case study, optimization framework was applied to design the optimal end-of-life technological solution for barrier films. The superstructure network utilized in this study is illustrated in FIG. 11, with the specific technologies for end-of-life treatments detailed in our previous publication. FIG. 11 presents the Superstructure Network of the life cycle of barrier films, from upstream processes, to the down-stream end-of-life processes. Except for landfilling, each end-of-life process also produces a by-product (electricity from incineration, pellets from downcycling, barrier film from mechanical and solvent cleaning (MASC), polyethylene (PE) and polyamide6 (PA6) from solvent targeted recovery and precipitation, and pyrolysis oil from the pyrolysis process. The pelletizing-A and -B processes are both downcycling processes producing pellets that can be used for lower-quality products but have different operational conditions. Details of each technology can be found in our previous publication. The focus of this study is to identify the most effective end-of-life technological solutions that lower GHG emissions produced by the supply chain within a cradle-to-grave system boundary while balancing cost-effectiveness, circularity, and resilience. The functional unit for this analysis is defined as the consumption of 1 metric ton of barrier film. These uncertainties arise from operational conditions of recovery processes and the quality of recycled materials over multiple recovery cycles. To account for these uncertainties, we assumed a uniform distribution for the uncertainty ranges in both the life cycle inventory and techno-economic data. For further details regarding the sources and modeling of uncertainties in this case study, we refer the reader to our previous publication.

### 2.5 Software Tool (TranZero)

We developed TranZero, an advanced analytical tool designed to accelerate cost-optimal GHG emission reduction across industries. TranZero employs a flexible, multi-layered analytical engine to identify and evaluate emission reduction strategies that optimize costs and enhance circularity while promoting supply chain resilience. Specifically tailored for our case study on barrier film waste management, the software features an intuitive, user-friendly interface that enables scenario analysis and supply chain design, facilitating the transition toward resource efficiency and emission reduction for these films.

The platform is designed to be accessible to users with varying levels of technical expertise, enabling them to explore and evaluate alternative solutions effectively. By integrating advanced computational methods into an approachable interface, the software enhances the decision-making process, making it both efficient and informed. This tool empowers stakeholders to analyze trade-offs between environmental and economic objectives, ensuring robust and sustainable solutions for minimizing GHG emissions.

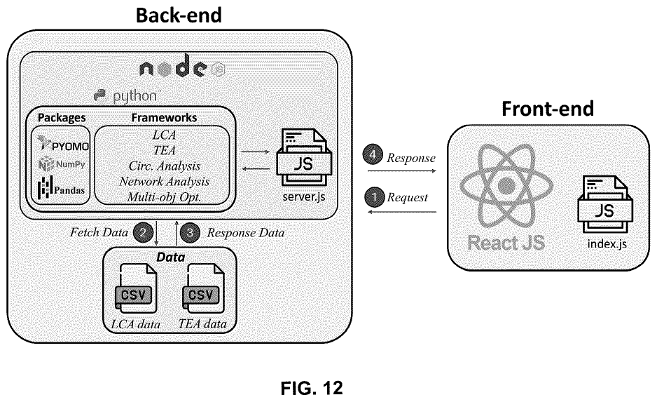

FIG. 12 illustrates the client-server model of TranZero. On the back-end, TranZero is built using Python, leveraging Python-based platforms and packages to develop the computational framework for the life cycle optimization model. It employs various Python libraries, including PYOMO for multi-objective optimization, Ipopt (for solving the non-linear problem, where non-linearity is caused by the resilience constraint) and Gurobi (for solving the linear problem, when the resilience constraint is inactive) as optimization

solvers, and NumPy, Pandas, and Plotly for data handling and visualization, among others. Some of these packages are depicted in FIG. 12. The underlying life cycle and techno-economic data are stored in CSV files, which are dynamically retrieved by the Python framework during execution. To ensure efficient management of the back-end and seamless integration with the user-facing front-end, the Python framework is encapsulated within a Docker environment.

On the front-end, the software is built using the React framework, providing a dynamic and responsive user interface. When a user submits an inquiry, the request is transmitted to the back-end, where the system retrieves the necessary data from CSV files. The relevant data is then processed, and appropriate calculations are performed to generate quantitative outputs. Finally, the computed results are sent back to the front-end for visualization and user interpretation. FIG. 12 illustrates the interaction between the back-end and front-end frameworks, detailing the software's technical workflow.

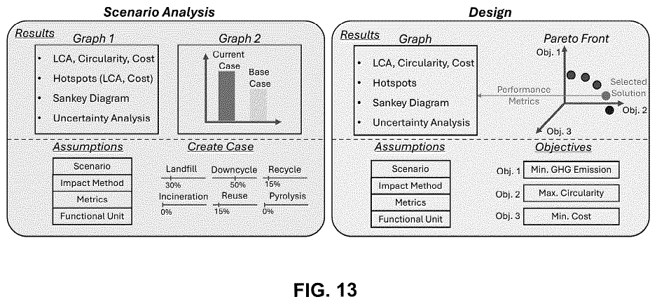

TranZero for barrier films is divided into two primary components: Scenario Analysis and Design. The Scenario Analysis module evaluates various emission reduction and circularity scenarios through a comprehensive approach that includes life cycle, techno-economic, circularity, and material flow analyses. Its primary objective is to enable what-if analyses by comparing different scenarios against each other and against the base (business-as-usual) case. Although this module does not design optimal supply chains, it forms the foundational layer of the software's analytical engine, empowering users to conduct robust comparative scenario assessments. FIG. 13 illustrates the Scenario Analysis interface, which is organized into three main sections: Assumptions, Create Scenario, and Results. In the Assumptions section, users can select the scenario group. To facilitate an apples-to-apples comparison, we define two distinct scenario groups, i.e., the “Current Opportunity” scenario and the “Future Opportunity” scenario groups. These scenarios allow for a systematic evaluation of the supply chain design under different technological availability conditions. In the Current Opportunity scenario group, only end-of-life solutions that are currently commercially available are considered from the superstructure network. For barrier films, these options include landfilling, incineration, and downcycling through pelletizing the waste. This scenario is particularly valuable for identifying opportunities that exist “today” to design supply chains. It is also highly relevant for decision-making processes where the large-scale implementation of commercially mature technologies is of paramount importance. In contrast, the Future Opportunity scenario group expands the scope by including all end-of-life solutions in the superstructure network, irrespective of their current commercial-scale availability. This approach enables the exploration of the potential for emission reduction with the full set of known technologies, regardless of their readiness level or uncertainties associated with their technological evolution. The Future Opportunity scenario group provides insights into the long-term potential for achieving carbon neutrality as technologies mature and become commercially viable. This allows for a clear comparison of the carbon neutrality potential, cost-effectiveness and resilience of supply chain under existing technological constraints versus a scenario unconstrained by commercial readiness. Together, these analyses provide a comprehensive view of both immediate opportunities and future pathways for reducing emissions and promoting circularity and resilience of the supply chain of multilayer films. In the Main Assumptions section, users can choose the preferred life cycle impact assessment method as well as the upstream life cycle inventory data, selecting from options such as USLCI v2023 or Ecoinvent v3.8. They can also specify the circularity and cost indicator of interest, which, at present, is limited to the circularity and cost objectives outlined in the present disclosure. Additionally, users have the flexibility to adjust the functional unit (metric tons of barrier film consumed). In the Create Case section, users can build their case study or scenario by selecting one or more technologies for treating multilayer plastic films at the end-of-life. The percentage values displayed in FIG. 13 represent the proportion of the film processed by each selected technology. Finally, the Results section provides a comprehensive overview of environmental impacts, including GWP, and identifies environmental and cost hotspots across the supply chain to highlight processes with the highest impacts. This section also features a Sankey diagram illustrating plastic flows within the system. The underlying data and results pertaining to the Analysis section are discussed in detail in our previous publication in the current study, however, our primary focus is on the insights derived from the Design module, specifically the optimization outcomes.

The Design module, illustrated in FIG. 5, employs the mathematical framework to optimize supply chain configurations. It identifies the most cost-effective and circular emission reduction strategies by selecting the best available technologies. This module consists of three key sections: Assumptions, Objectives, and Results. In the Assumptions section, users can define parameters related to the scenario group, life cycle impact assessment method, upstream life cycle inventory data, and functional unit value, similar to those in the Scenario Analysis module. The Objectives section allows users to specify their optimization goals, categorized into three objective groups: environmental, circularity, and cost objectives. The current version supports only GWP as the environmental objective, alongside the circularity and cost objectives. Once assumptions and objectives are set, users can execute the optimization and review results, displayed in the upper portion of the Design module in FIG. 13. As shown in FIG. 13, the interface is divided into two main sections: Scenario Analysis on the left and Design on the right. The Scenario Analysis section allows users to compare different decarbonization and circularity scenarios through life cycle assessment, techno-economic analysis, circularity assessment, and material flow analysis. The Design section incorporates a multi-objective optimization framework to identify the most cost-effective, circular, and low-emission pathways for barrier film treatment. On the top right-hand side of the Design module, the Pareto frontier represents all optimized solutions, visualized in a three-dimensional interactive plot. To enhance usability, the interface allows users to rotate, zoom, and explore the 3D space dynamically. Additionally, the Pareto frontier is displayed as a scatter plot, enabling users to select individual solutions by clicking on corresponding data points. On the top left-hand side of the Design module, users can explore detailed results, including LCA, circularity, and cost, hotspot identification, and Sankey diagrams depicting material flows and selected technologies. This innovative visualization allows users to efficiently interpret performance metrics without cluttering the Pareto frontier itself. This approach enhances clarity and facilitates a more intuitive understanding of trade-offs between competing objectives.

Overall, this innovative front-end allows users to harness TranZero's layered analytical engine for both comparative scenario analysis (Scenario Analysis) and multi-objective optimization (Design). By integrating advanced yet intuitive visualizations, the software ensures a seamless user experience, enabling both high-level assessments and in-depth optimization with clarity and ease of interpretation.

### 3. RESULTS AND DISCUSSIONS

In this section, we first present the results of life cycle optimization for the barrier film case study, high-lighting the optimal technologies and the corresponding GWP, circularity, and cost of the supply chain. We then examine the impact of incorporating a resilience constraint in the optimization framework by comparing two scenarios: one without resilience considerations and one with them. This analysis demonstrates how accounting for resilience influences optimization outcomes, contributing to more robust and informed decision-making. Finally, we showcase the TranZero interface and its broader applicability beyond barrier films, demonstrating its capabilities in tackling decarbonization challenges for various products.

### 3.1 Single-Objective Life Cycle Optimization

In this section, we present the life cycle optimization results by conducting three separate single-objective optimizations: one to minimize GWP, one to maximize circularity, and one to minimize cost. This approach allows us to assess the impact of incorporating the resilience constraint on each objective individually and to understand how the solution space evolves. To illustrate these effects, we focus on the best-case uncertainty scenario while ensuring that the findings remain generalizable and independent of specific uncertainty scenarios. The solutions obtained from single-objective optimization correspond to the extreme cases of multi-objective optimization, where one objective is fully prioritized. In essence, these solutions are equivalent to solving each objective independently, with the other objectives exerting no influence on the outcome.

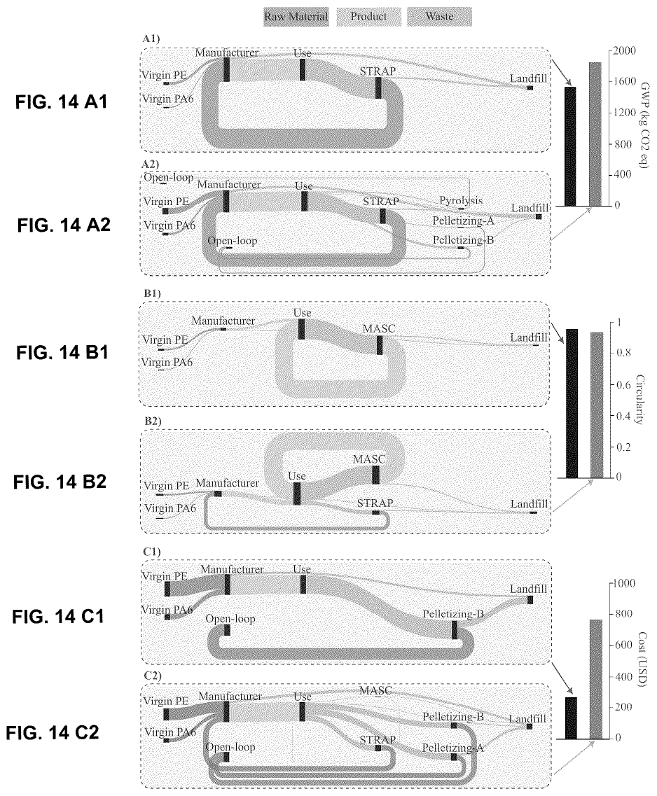

When minimizing GWP without the resilience constraint (or window of vitality constraint), the optimization selects solvent targeted recovery and precipitation (STRAP) as the sole end-of-life solution. However, when the resilience constraint is applied, while STRAP remains the dominant choice, additional end-of-life technologies, i.e. pelletizing-A, pelletizing-B, and pyrolysis, also emerge in the solution space. These technologies rank as the second, third, and fourth most effective options for minimizing GWP after STRAP. The inclusion of these additional technologies enhances network diversity, ensuring that DoSO remains within the window of vitality. This diversification strengthens the system's ability to withstand perturbations (e.g., technological failure for treating end-of-life waste) by maintaining infrastructure for multiple technologies, thereby facilitating their scalability in case of disruptions. We define this as technological resilience, which improves when the system is designed with the resilience constraint. However, it is important to note that the GWP of the resilient design is higher than that of the non-resilient design. This is because, rather than exclusively selecting the most efficient technology for emissions reduction (STRAP), the system incorporates less efficient alternatives to enhance overall resilience. FIGS. 14 A1 and 14 A2 illustrate the downstream process flow diagrams for the supply chain of barrier films, comparing the minimum GWP designs without and with resilience, respectively.

When maximizing circularity without the resilience constraint, the optimization selects mechanical and solvent cleaning (MASC) as the preferred technology since it is a closed-loop reuse system, keeping materials within the production cycle and achieving the highest circularity. However, when the resilience constraint is introduced, while MASC remains the dominant solution, STRAP is also included to enhance technological diversity and resilience. Unlike the GWP-minimization case, where multiple technologies were needed to ensure resilience, the combination of MASC and STRAP alone is sufficient to maintain system stability without requiring additional pathways. This is because circular systems inherently foster resilience [10]. Closed-loop recycling reduces reliance on virgin materials and provides multiple routes for reintroducing recovered materials into manufacturing and consumption cycles. Moreover, the circularity indicator values for the designs with and without resilience differ only slightly. This is because STRAP, while not as effective as MASC in circularity, still contributes significantly to material recovery, minimizing the overall loss of efficiency when resilience is incorporated. FIGS. 14 B1 and 14 B2 illustrate the downstream process flow diagrams for the supply chain of barrier films, comparing the maximum circularity designs without and with resilience, respectively.

When minimizing cost without incorporating resilience, the optimization selects pelletizing-B as the end-of-life technology for multilayer film waste. This is due to its low capital and operating costs and its ability to generate revenue through downcycling byproduct sales. However, when resilience is introduced as a constraint, the optimization selects multiple technologies. While pelletizing-B remains the dominant choice, pelletizing-A, STRAP, and MASC are also included as the second, third, and fourth most cost-effective solutions. This diversification improves technological resilience, ensuring that the system is not solely dependent on the cheapest option. However, the immediate trade-off for incorporating resilience is a significant increase in overall cost. Specifically, the resilient design is three times more expensive than the non-resilient counterpart when evaluated from a short-term economic perspective. It is important to recognize, though, that this short-term view may not fully capture the true economic implications. In the long run, supply chain disruptions can substantially impact profitability, potentially making resilient designs more cost-effective over extended periods [11]. Although such long-term economic impacts are beyond the scope of this study, they must be considered when interpreting the presented results. FIGS. 14 C1 and C2 illustrate the downstream process flow diagrams for the supply chain of multi-layer films, comparing the minimum cost designs without and with resilience, respectively.

FIG. 14 depicts the results of the single-objective optimization for (A) minimizing global warming potential (GWP), (B) maximizing circularity, and (C) minimizing cost. Subfigures 14 A1, 14 B1, and 14 C1 present the optimized solutions without the resilience constraint, while 14 A2, 14 B2, and 14 C2 display the results with resilience. This comparison highlights the impact of incorporating resilience on the optimization outcomes across different objectives.

### 3.2 Multi-Objective Life Cycle Optimization

In this section, the results of the multi-objective life cycle optimization are presented for the barrier film supply chain, aiming to identify the most effective technological alternatives for treating multilayer plastic film waste. A key focus is on examining the impact of incorporating resilience into the multi-objective optimization process.

We first introduce the Pareto frontier solutions for both cases, i.e., with and without resilience, to illustrate the trade-offs between GWP, circularity, and cost under different optimization constraints. Following this, we analyze the distribution of all possible solutions that arise from uncertainty scenarios, using a histogram to compare the robustness of the solutions in both cases. This comparison highlights the stability and reliability of the optimized supply chain under uncertain conditions.

To ensure clarity and focus, our analysis centers on a single representative Pareto front, specifically, the one derived from the best-case uncertainty scenario. By comparing the trade-offs and solution space between the cases with and without the resilience constraint, we aim to demonstrate how resilience influences the multi-objective optimization. This analysis provides insight into how the resilience constraint shapes decision-making, particularly in determining the optimal operating point on the Pareto front. Understanding these effects is crucial for designing cost-effective, circular, and resilient supply chains that can adapt to future uncertainties.

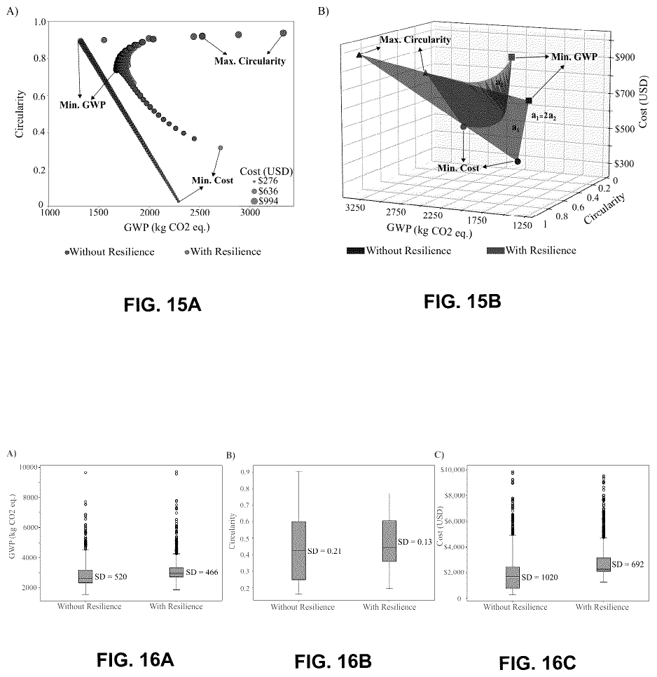

The Pareto front for the best-case uncertainty scenario is depicted in FIGS. 15A and 15B, with both a 2D representation (FIG. 15A) and a 3D representation (FIG. 15B). FIG. 15 specifically presents the results of the multi-objective optimization represented as a Pareto frontier. FIG. 15A shows the 2D Pareto front, while FIG. 15B presents the 3D Pareto front for the best-case uncertainty scenario. The design incorporating resilience has a smaller solution space (half) and yields less extreme solutions compared to the design without resilience. a₁ and a₂ in FIG. 15B show the area of each Pareto front. Min. GWP, Max. Circularity, and Min. cost correspond to the extreme solutions depicted in FIG. 14. As shown in these figures, the extreme solutions along the Pareto front, those corresponding to minimum GWP, maximum circularity, and minimum cost (identical to the single-objective solutions discussed in the previous section), shift toward less extreme positions when the resilience constraint is introduced. This means that while the objective values become slightly less optimal, the overall system becomes more resilient. In contrast, the solutions in the absence of resilience appear to be more extreme, as the optimization focuses solely on selecting the most efficient technology for each objective without considering diversity or adaptability. This highlights the fundamental trade-off introduced by resilience: optimizing purely for efficiency leads to more specialized but potentially vulnerable solutions, whereas incorporating resilience results in a more balanced and resilient system capable of withstanding disruptions.

Secondly, the case with resilience has a smaller design space compared to the case without resilience. In FIG. 15B, the area of the Pareto frontier for the case with the resilience constraint is half that of the case without it. This indicates that a design incorporating resilience results in fewer operational points and a more constrained operational space. The reason for this reduction is that a resilient design eliminates solutions that do not meet resilience criteria. By filtering out non-resilient solutions, the operating space shrinks, ensuring that all remaining solutions maintain system stability and adaptability. While this limits the number of possible design choices, it guarantees that any selected solution is inherently more resilient against disruptions.

A robustness analysis across was conducted all uncertainty scenarios for the three objectives (GWP, circularity, and cost) to assess how uncertainty affects the stability of the optimization results. FIGS. 16A-16C present the distribution of objective values across all uncertainty scenarios for GWP (FIG. 16A), circularity (FIG. 16B), and cost (FIG. 16C). FIGS. 16A-16C provides box-and-whisker plots of multi-objective optimization results across all uncertainty scenarios, with FIGS. 16A-16C representing the distribution of results for the GWP, circularity, and cost objectives, respectively. The standard deviation (SD) of the distributions for the design with resilience is lower than that of the design without resilience, indicating that solutions are more robust when resilience is included as a constraint.

Overall, the GWP and cost objectives exhibit less variability or greater solution robustness compared to circularity in both cases, with and without resilience. This is primarily due to uncertainties associated with the STRAP and MASC technologies, which are the most circular strategies. Specifically, variations in material quality over multiple recovery cycles introduce uncertainty in the circularity objective. A more detailed discussion on this issue can be found in our previous publication.

When resilience is included as a constraint, the solutions become more robust across all objectives compared to the case without resilience. This increased robustness is a direct result of the shrinking operating space discussed earlier, where non-resilient solutions are removed, leading to a more stable set of outcomes.

The standard deviations (SD) displayed in the box plots in FIGS. 16A-16C confirm this trend. The solutions with the resilience constraint have a lower SD, indicating less variation in results and, therefore, greater robustness in the optimization outcomes.

Additionally, for GWP and cost, the case with resilience has a higher median compared to the case without resilience. This suggests that while the overall efficiency of the system is reduced, resilience is ensured, demonstrating the trade-off between optimality and system stability in life cycle optimization.

### 3.3 TranZero's Interface

In this section, screenshots of the current interface of TranZero-Barrier Film Version are presented to provide an overview of the tool and enhance usability. These visual representations aim to familiarize users with the tool's interface and functionalities, facilitating its effective use for life cycle optimization and decision-making.

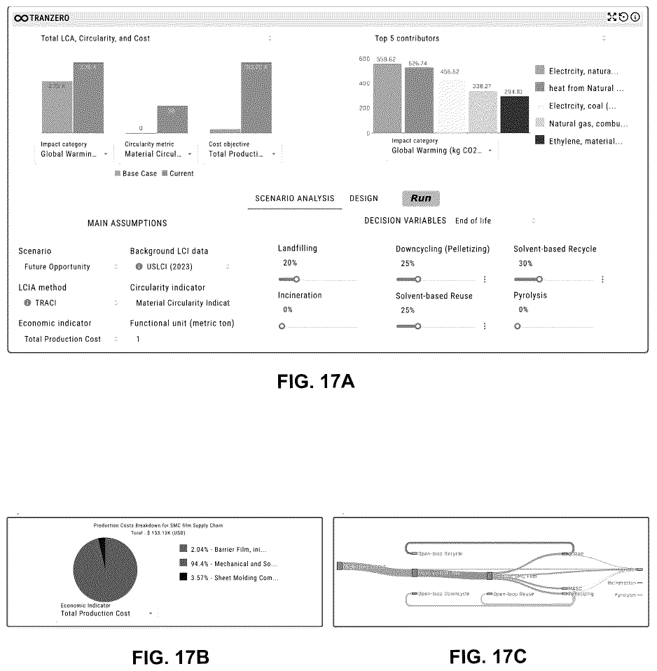

FIGS. 17A-17C presents screenshots of the user interface of the Scenario Analysis section of the software. FIG. 17A displays the main interface, which includes key assumptions, decision variables, and two primary output figures: the total LCA, circularity, and cost metrics (top left), and an environmental hotspot analysis (top right). FIGS. 17B and 17C showcase additional visualization options available within the software, with FIG. 17B illustrating a cost hotspot analysis and FIG. 17C depicting a material flow analysis of plastics using a Sankey diagram. The results of the Scenario Analysis section are presented in our previous publications.

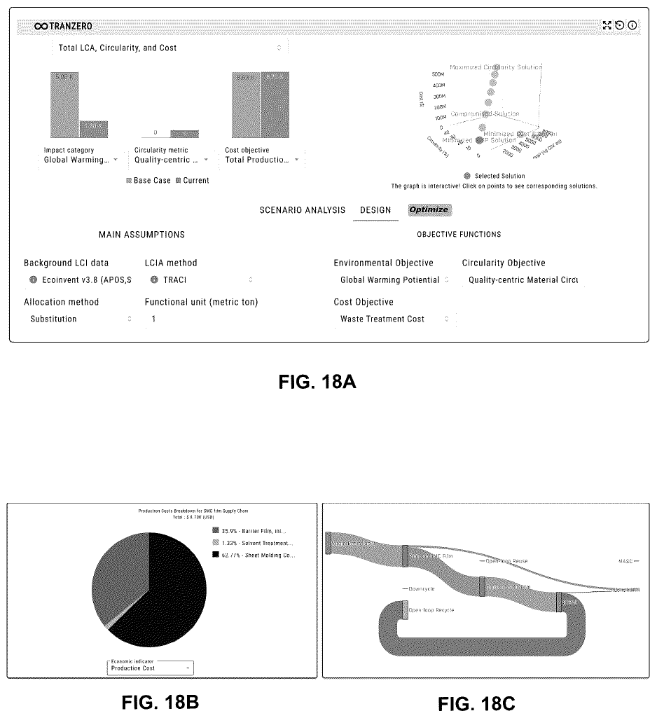

FIGS. 18A-18C presents screenshots of the user interface of the Design section of the software. FIG. 18A displays the main interface, which includes key assumptions, optimization objectives, and two primary figures: the Pareto frontier (top right) and performance metrics (top left). FIGS. 18B and 18C provide additional visualization options, with FIG. 18B showing a cost hotspot analysis and FIG. 18C depicting a plastic flow Sankey diagram, where the selected technologies are represented as nodes. These figures illustrate the tool's capabilities in optimizing supply chain design for decarbonization and circularity.

These figures serve as examples, and for a more comprehensive exploration of the tool's capabilities, users can access the software via the provided link. In addition, a user tutorial is available upon opening the tool's URL, guiding users through its features and functionalities to enhance usability and ensure effective application.

### 4. CONCLUSIONS

In the present disclosure, a comprehensive framework has been disclosed for designing supply chains that achieve emission reduction while maintaining profitability and ensuring resilience. First, we formulated a multi-objective optimization approach aimed at minimizing greenhouse gas emissions, maximizing circularity, and minimizing cost, while incorporating constraints to enhance system resilience.

Second, this framework was applied to a case study on the circularization of barrier films, identifying the optimal pathways and evaluating the trade-offs between emissions reduction, circularity, and cost. A key focus was the incorporation of resilience as an optimization constraint and its impact on designing for carbon neutrality. Results show that when resilience is considered, optimization solutions shift toward less extreme points, as the system prioritizes resilience over maximum efficiency. Additionally, the design space for the resilience-constrained case is smaller, as non-resilient solutions are filtered out, leading to a more constrained but more stable operational space. This trade-off demonstrates that while designing for resilience reduces overall efficiency, it enhances the system's ability to withstand disruptions, an aspect often overlooked in decarbonization roadmaps, where efficiency is the primary focus. Incorporating resilience into these roadmaps is essential to ensuring long-term sustainability.

Finally, a user-friendly software tool, TranZero, was developed which integrates a layered analytical engine for comparative assessments of technologies and applies the present optimization framework for sustainable and circular design. This tool facilitates decision-making by providing a structured approach to evaluating trade-offs and developing resilient, low-emission supply chains. While this version is designed for the barrier films supply chain, the tool is built with a flexible and adaptable engine, making it easily applicable to other products and industries. Additionally, while the current decision variables are limited to technological alternatives, future iterations can incorporate variables related to product design, business strategy, nature-based solutions, and policy interventions, enabling more comprehensive set of decision variables.

### DISCUSSION

The sustainability analysis indicates a trade-off among minimizing greenhouse gas (GHG) emissions, maximizing circularity, and minimizing costs. The Recycle scenario (STRAP) performs better than others in terms of GWP and cost. However, the Reuse scenario (MASC) achieves maximum circularity. Despite the MASC process leading to the recovery of a higher-value product, its elevated energy and raw material consumption result in higher GWP and costs compared to the STRAP process. The user-friendly software prototype developed serves as a tool for stakeholders to observe these trade-offs across different combinations of EOL strategies.

### CONCLUSIONS AND RECOMMENDATIONS

In conclusion, the overarching goal of this project was to overcome challenges and identify opportunities associated with EOL recovery of multilayer plastic films used in sheet molding composites (SMC) production (SMC films). A thorough analysis was performed of various EOL strategies used to treat SMC films. The technical obstacles were explored to reuse and downcycle the EOL material. The study also employs life cycle assessment (LCA), circularity analysis, and techno-economic analysis (TEA) to establish a comprehensive understanding of the sustainability implications. Moreover, in this study, the system boundary of LCA and TEA was expanded to account for multiple life cycles and the impact of ultimate EOL of material. This approach provides a more robust assessment of circularity and life cycle impacts. Overall, the sustainability results indicate a trade-off between minimizing greenhouse gas (GHG) emissions, maximizing circularity, and minimizing costs. The Recycle scenario (STRAP) emerges as a top performer in terms of Global Warming Potential (GWP) and cost, while the Reuse scenario (MASC) achieves maximum circularity. A user-friendly software prototype named Sustainability And Circularity Overview (SACO) is developed to facilitate stakeholder decision-making by visualizing these trade-offs across different EOL strategies. The software can be expanded to cover other production systems and supply chains across chemical and material industry.

### Computer-implemented System

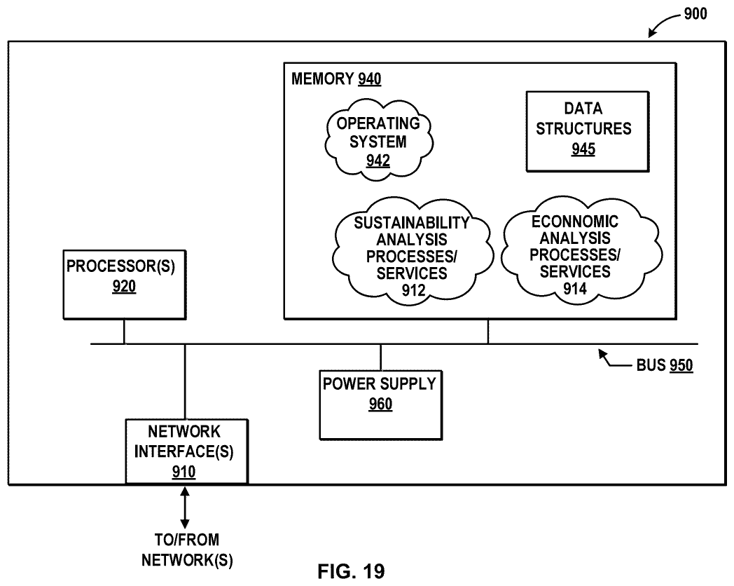

FIG. 19 is a schematic block diagram of an example device 900 that may be used with one or more embodiments described herein, e.g., as a component of the disclosed system.

Device 900 comprises one or more network interfaces 910 (e.g., wired, wireless, PLC, etc.), at least one processor 920, and a memory 940 interconnected by a system bus 950, as well as a power supply 960 (e.g., battery, plug-in, etc.).

Network interface(s) 910 include the mechanical, electrical, and signaling circuitry for communicating data over the communication links coupled to a communication network. Network interfaces 910 are configured to transmit and/or receive data using a variety of different communication protocols. As illustrated, the box representing network interfaces 910 is shown for simplicity, and it is appreciated that such interfaces may represent different types of network connections such as wireless and wired (physical) connections. Network interfaces 910 are shown separately from power supply 960, however it is appreciated that the interfaces that support PLC protocols may communicate through power supply 960 and/or may be an integral component coupled to power supply 960.

Memory 940 includes a plurality of storage locations that are addressable by processor 920 and network interfaces 910 for storing software programs and data structures associated with the embodiments described herein. In some embodiments, device 900 may have limited memory or no memory (e.g., no memory for storage other than for programs/processes operating on the device and associated caches).

Processor 920 comprises hardware elements or logic adapted to execute the software programs (e.g., instructions) and manipulate data structures 945. An operating system 942, portions of which are typically resident in memory 940 and executed by the processor, functionally organizes device 900 by, inter alia, invoking operations in support of software processes and/or services executing on the device. These software processes and/or services may include analysis and design software for sustainable circular economy for multilayer barrier films processes/services 912/914 described herein. Note that while the sustainable circular economy analysis processes/services 912/914 is illustrated in centralized memory 940, alternative embodiments provide for the process to be operated within the network interfaces 910, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the analysis and design software for sustainable circular economy for multilayer barrier films processes/services 912/914 is shown as a standalone process, those skilled in the art will appreciate that this process may be executed as a routine or module within other processes.

What is claimed is:

1. A system for analyzing and designing sustainable and circular economies for plastic waste products, comprising:
a memory; and
a processor in communication with the memory, wherein the processor is operable to execute a set of instructions located on the memory to generate an optimized sustainable and circular economy using a plurality of end-of-life technologies for a process that produces a waste material by:
defining an objective function for each of an environmental impact indicator, a circularity indicator, an economic indicator, and a resilience indicator;
wherein each objective function is based on a plurality of technology matrices for a plurality of input-output relationships between a plurality of products, processes, and technological flows and a plurality of intervention matrices for a plurality of environmental flows emitted or consumed for each process of the technology matrices;
for each end-of-life technology of the plurality of end-of-life technologies, performing a multi-objective optimization by:
solving a series of single objective optimizations, each single objective optimization corresponding to an individual objective function, wherein all remaining objective functions are used as threshold value constraints on each of the single objective optimizations; and
systematically varying the threshold values of the remaining objective functions to identify the optimized sustainable and circular economy for the process when employing each end-of-life technology.

2. The system of claim 1, wherein the multi-objective optimization is further performed by:
introducing a penalty variable and slack parameters while solving the series of single objective optimizations.

3. The system of claim 1, wherein the resilience indicator acts as a constraint of the multi-objective optimization.

4. The system of claim 1, wherein the objective function for the environmental impact indicator estimates an environmental impact by estimating a resultant flow of materials having an environmental impact for the process when employing the plurality of end-of-life technologies.

5. The system of claim 1, wherein the objective function for the circularity indicator estimates a degree of economic circularity by estimating a quantity of raw material consumed, a quantity of waste material generated, and a quantity of total product manufactured by the process when employing the plurality of end-of-life technologies.

6. The system of claim 5, wherein the objective function for the circularity indicator accounts for a quantity of recovered waste material that is utilized as raw input material for a secondary process.

7. The system of claim 1, wherein the objective function for the economic indicator estimates a total supply chain cost for the process when employing the plurality of end-of-life technologies by isolating cost variations in a downstream phase and an end-of-life phase of the process.

8. The system of claim 1, wherein the objective function of the resilience indicator is optimized only for flows in the process directly related to raw material inputs, a manufactured product, and the waste material.

9. The system of claim 1, wherein an uncertainty factor is applied to the multi-factor optimization to account for the uncertainty across the plurality of technology matrices, the plurality of intervention matrices, and a demand for a manufactured product.

10. The system of claim 1, wherein the processor is further operable to:
compare the optimized sustainable and circular economy for each of the end-of-life technologies to determine an overall optimized sustainable and circular economy for the process.

11. The system of claim 10, wherein the processor is further operable to:
recommend a plan for achieving the optimized sustainable and circular economy for the process.

12. The system of claim 1, wherein the processor is further operable to receive an optimization goal, wherein the multi-objective optimization prioritizes the optimization goal while identifying the optimized sustainable and circular economy.

13. A method for analyzing and designing sustainable and circular economies for plastic waste products, comprising:
defining an objective function for each of an environmental impact indicator, a circularity indicator, an economic indicator, and a resilience indicator;
wherein each objective function is based on a plurality of technology matrices for a plurality of input-output relationships between a plurality of products, processes, and technological flows and a plurality of intervention matrices for a plurality of environmental flows emitted or consumed for each process of the technology matrices;
for each end-of-life technology of a plurality of end-of-life technologies:
solving a series of single objective optimizations, each single objective optimization corresponding to an individual objective function, wherein all remaining objective functions are used as threshold value constraints on each of the single objective optimizations; and
systematically varying the threshold values of the remaining objective functions to identify an optimized sustainable and circular economy for a process that produces a waste material when employing each end-of-life technology; and
generating an optimized sustainable and circular economy for the process by comparing the optimized sustainable and circular economy for each of the end-of-life technologies to determine an overall optimized sustainable and circular economy for the process.

14. The method of claim 13, wherein the resilience indicator acts as a constraint of solving the series of single objective optimizations and systematically varying the threshold values to identify the optimized sustainable and circular economy.

15. The method of claim 13, wherein the objective function for the environmental impact indicator estimates an environmental impact by estimating a resultant flow of materials having an environmental impact for the process when employing the plurality of end-of-life technologies.

16. The method of claim 13, wherein the objective function for the circularity indicator estimates a degree of economic circularity by estimating a quantity of raw material consumed, a quantity of waste material generated, and a quantity of total product manufactured by the process when employing the plurality of end-of-life technologies.

17. The method of claim 13, wherein the objective function for the economic indicator estimates a total supply chain cost for the process when employing the plurality of end-of-life technologies by isolating cost variations in a downstream phase and an end-of-life phase of the process.

18. The method of claim 13, wherein the objective function of the resilience indicator is optimized only for flows in the process directly related to raw material inputs, a manufactured product, and the waste material.

19. The method of claim 13, further comprising:
recommending a plan for achieving the optimized sustainable and circular economy for the process.

20. The method of claim 13, further comprising
receiving an optimization goal, wherein the series of single objective optimizations are solved while prioritizing the optimization goal.
